(19) United States
(12) Patent Application Publication
(10) Pub. No.: US 2016/0112279 A1
(43) Pub. Date: Apr. 21, 2016

(54) Sensor-based Distributed Tangible User Interface

(71) Applicants: Jeevan James Kalanithi, San Francisco, CA (US); David Jeffrey Merrill, Somerville, MA (US); Patricia Emilia Maes, Cambridge, MA (US)

(72) Inventors: Jeevan James Kalanithi, San Francisco, CA (US); David Jeffrey Merrill, Somerville, MA (US); Patricia Emilia Maes, Cambridge, MA (US)

(73) Assignee: MASSACHUSETTS INSTITUTE OF TECHNOLOGY, Cambridge, MA (US)

(21) Appl. No.: 14/519,050

(22) Filed: Oct. 20, 2014

(51) Int. Cl. H04L 12/24; G06F 3/0484; H04B 7/24; H04L 29/08

(52) U.S. Cl. CPC H04L 41/22; H04L 67/10; G06F 3/04847; G06F 3/04842; H04B 7/24

(57) ABSTRACT

A distributed tangible user interface comprises compact, self-powered, tangible user interface manipulative devices having sensing, display, and wireless communication capabilities, along with one or more associated digital content or other interactive software management applications. The manipulative devices display visual representations of digital content or program controls and can be physically manipulated as a group by a user for interaction with the digital information or software application. A controller on each manipulative device receives and processes data from a movement sensor, initiating behavior on the manipulative and/or forwarding the results to a management application that uses the information to manage the digital content, software application, and/or the manipulative devices. The manipulative devices may also detect the proximity and identity of other manipulative devices, responding to and/or forwarding that information to the management application, and may have feedback devices for presenting responsive information to the user.

### RELATED APPLICATIONS

This application is a continuation of U.S. patent application Ser. No. 12/365,885, filed Feb. 4, 2009, now abandoned, which claims the benefit of U.S. Provisional Application Ser. No. 61/063,479, filed Feb. 4, 2008, the entire disclosures of which are herein incorporated by reference.

### FIELD OF THE TECHNOLOGY

The present invention relates to computer user interfaces and, in particular, to a tangible user interface that is distributed and sensor-based.

### BACKGROUND

Humans exhibit particular skill at sifting, sorting, and otherwise manipulating large numbers of small physical objects. When a human performs a task such as overturning a container of nuts and bolts and sifting through the resulting pile to find one of a particular size, or spreading photographs out on a tabletop and sorting them into piles, he or she uses both hands and all of his or her fingers actively and efficiently. However, when the human sorts digital information or media such as digital photographs or emails, the task typically does not effectively leverage the full range of physical manipulation skills. For example, one typical user interaction with a modern graphical user interface (GUI) is to click on an icon with a mouse, drag the icon to another location on the screen, and then drop it to reposition it or to assign the data it represents to a folder. This so-called “direct manipulation” of information, as afforded by a GUI, is a poor substitute for a human's facile all-finger, two-handed manipulation of physical items.

Tangible user interfaces (TUIs) have made some progress towards leveraging human physical manipulation abilities for interaction with digital information. For example, Fitzmaurice et al. pioneered physical ‘handles’ to digital objects, in which TUIs with handles operate by sensing the user's manipulation of each handle and displaying a co-located visual representation of the data being manipulated [Fitzmaurice, G. W., Ishii, H., Buxton, W.: Bricks, “Laying the foundations for graspable user interfaces”, Proceedings of CHI '05 (1995), 422-449]. Some TUIs, like the Designer's Outpost [Klemmer. S., Nevwnan, M., Farrell. R., Bilezikjian. M., Landay. J., “The designers' outpost: a tangible interface for collaborative web site”, Proceedings of UIST '01 (2001), 1-10] and DataTiles [Rekimoto, J., Ullmer, B., Oba, H., “Datatiles: a modular platform for mixed physical and graphical interactions”, Proceedings of CHI '01, New York, N.Y., USA, ACM Press (2001), 269-276], project graphics onto the handles themselves, while others, like Sensetable [Patten, J., Ishii, H., Hines, J., Pangaro, G., “Sensetable: a wireless object tracking platform for tangible user interfaces”, Proceedings of CHI '01 (2001), 253-360], utilize them simply as generic tangible cursors to the overlaid GUI. Advantages of TUIs over GUIs include support for two-handed input (though recent touch-screen interfaces also support this [see, e.g., Han, J. Y., “Low-cost multi-touch sensing through frustrated total internal reflection”, Proceedings of UIST '05, New York, N.Y., USA, ACM Press (2005), 115-118]), reduced cognitive load as compared to a GUI, faster target acquisition, greater facilitation of multi-person interaction, and a reduction in the level of indirection between a person's hand and the actual computation taking place when adjusting a parameter [Fitzmaurice, G., “Graspable User Interfaces”, PhD thesis, University of Toronto (1997)]. These features make handle-based TUIs more direct form of manipulation than a GUI alone.

Another class of tangible user interface largely dispenses with the GUI paradigm, featuring physical objects that directly embody the digital information or media that they represent. These TUIs do not implement handles to manipulate a GUI overlay; rather, such as in Ishii's Music Bottles [Ishii, H., Mazalek, A., Lee, J., “Bottles as a minimal interface to access digital information”, CHI '01, Extended abstracts on human factors in computing systems, New York, N.Y., USA, ACM Press (2001), 187-188] and Want et al.'s work with embedded RFID tags [Want, R., Fishkin, K. P., Gujar, A., Harrison, B. L., “Bridging physical and virtual worlds with electronic tags”, Proceedings of CHI '99, New York, N.Y., USA, ACM Press (1999), 370-377], the shape and features of the objects themselves suggest the semantics of the interaction. The inherent coupling between form and function in this class of TUIs brings an increased directness to an interaction with digital information or media. However, this gain in directness comes at a cost: since they represent the underlying data implicitly with their physical form, UIs featuring special-purpose objects can be more limited to a particular application domain or style of interaction.

Sensor networks consist of collections of sensing and communication devices that can be distributed spatially. They are capable of exhibiting coordinated behavior, forming a kind of “functional fabric” in the spaces that they inhabit without requiring external sensing or power infrastructure. Sensor network nodes can be built with an array of sensing technologies that can be used to build rich models of local interactions and their surroundings. The sensor network community has focused a great deal of effort on the technical issues that it faces. Many of these present themselves as tradeoffs in the design space. Longer battery life for a sensor node requires that other priorities, such as battery size, radio transmit range, or frequency of communication must suffer. The use of ultra-small components can cause the device to require more specialized and expensive assembly, so they may be avoided in favor of larger components, resulting in a larger device. Other challenges relate to implementing the desired sensor network behavior, such as coordinated sensing of events and mobile code that can be transmitted easily to another node and run immediately [Akyldiz, I F., Su, W., Sarkarasubramaniam, Y., Cayirci, E. “Wireless sensor networks: a survey”, Computer Networks, 38(4), (2002), 393-422].

While there has been a great deal of development activity directed to these and other aspects of wireless sensor networks in which many computationally-equipped nodes cooperate to perform a wide variety of tasks, a coherent set of design principles for Human-Computer Interaction (HCI) problems has not yet been developed. Little research effort has been invested in using sensor networks as user interfaces, and, in particular, in combining sensor network technologies with features from GUIs and TUIs. Such distributed TUIs (dTUIs), also called Sensor Network User Interfaces (SNUIs), in combination with a defined SNUI interaction language, could increase the directness of a user's interaction with digital information or media. Existing work relating to the concept of an SNUI interaction language by which a user might interact with digital information or media includes, for example, the “Smart-Its Friends” technique of pairing two personal devices by shaking them together at the same time is an example of grouping-by-gesture [Holmquist, L., Mattern, F., Schiele, B., Alahuhta. P., Beigi, M., Gellersen, H., “Smart-its friends: A technique for users to easily establish connections between smart artifacts”, Proceedings of UbiComp '01 (2001) 116-122]. In addition, Hinckley discusses several interactions based around the bumping of display screens into each other, including cooperative display sharing to create a larger viewing area for documents or photographs [Hinckley, K., “Synchronous gestures for multiple persons and computers”, Proceedings of UIST '03, New York, N.Y., USA, ACM Press (2003), 149-158]. Both projects make use of inertial data captured from an accelerometer, and are novel physical interactions with devices that could be adapted for use by an SNUI. BumpTop is a GUI-based interface that simulates the physics of real-world objects with inertia [Agarawala, A., Balakrishnan, R., “Keepin' it real: pushing the desktop metaphor with physics, piles and the pen”, Proceedings of CHI '06, New York, N.Y., USA, ACM Press (2006), 1283-1292], and prototypes a wide range of gestural language primitives for interactions with icons.

### SUMMARY

The present invention is a distributed tangible user interface comprising compact tangible user interface (TUI) manipulative devices with sensing, display, and wireless communication capabilities and associated digital content management and other software applications. The manipulative devices can be physically manipulated as a group by a user in order to permit a user to efficiently interact with digital information, media, and interactive software programs. A group of manipulatives, used in concert, thus form a physical, distributed, gesture-sensitive, human-computer interface. In the preferred embodiment, each TUI manipulative has its own sensing, feedback, and communication abilities. A controller on each manipulative device receives and processes data from a movement sensor, initiating behavior on the manipulative and/or forwarding the results to a management application that uses the information to manage the digital content, software application, and/or the manipulative devices. TUI manipulatives according to the preferred embodiment can sense their neighbors, allowing management applications to utilize topological arrangement. They detect the proximity and identity of other manipulative devices, responding to and/or forwarding that information to the management application, and may have feedback devices for presenting responsive information to the user. They can also be used to implement gestural interaction languages and HCI applications.

In one aspect, a tangible user interface according to the invention comprises a plurality of tangible user interface manipulative devices, each tangible user interface manipulative device being independently manipulable relative to the other tangible user interface manipulative devices. Each tangible user interface manipulative device comprises at least one wireless communications device, a visual display for digital content, a power source, at least one movement sensor, and at least one controller. The controller receives data from the movement sensor, processes the received data to derive movement parameters, and possibly forwards the derived movement parameters or initiating tangible user interface behaviour in response to the derived movement parameters. An associated management application sends digital content or behavior instructions to individual tangible user interface manipulative devices, receives derived movement parameters from at least one of the tangible user interface manipulative devices, processes derived movement parameters to derive instructions about management of the digital content or program behaviour, and changes program behavior or manages the digital content according to the derived instructions. The management application may send at least one of revised digital content or behavior instructions to individual tangible user interface manipulative devices according to the derived instructions. The tangible user interface manipulative devices may also comprise at least one neighborhood wireless communications device for sensing nearby tangible user interface manipulative devices, with the controller being further adapted for sensing the position of at least one nearby tangible user interface manipulative device, processing the position of, and any communication received from, the sensed nearby tangible user interface manipulative device in order to derive neighborhood information, and possibly forwarding the derived neighbourhood information to the management application or initiating tangible user interface behavior in response to the derived neighbourhood information.

In another aspect, the present invention is a method for facilitating user interaction with digital content or application programs, comprising the steps of displaying a visual representation of at least one of digital content or program control elements on a plurality of tangible user interface manipulative devices, such that a subset of the digital content or program control elements is displayed on any individual device, detecting at least one of a manipulation of at least one of the tangible user interface manipulative devices or a location-based relationship between at least two of the tangible user interface manipulative devices, and deriving digital content relationship information or instructions from the detected manipulation or relationship.

### BRIEF DESCRIPTION OF THE DRAWINGS

Other aspects, advantages and novel features of the invention will become more apparent from the following detailed description of the invention when considered in conjunction with the accompanying drawings wherein:

FIG. 1 is a block diagram of an exemplary embodiment of a sensor-based distributed tangible user interface, according to one aspect of the present invention;

FIG. 2 is a system diagram of an exemplary embodiment of a tangible user interface manipulative, according to one aspect of the present invention;

FIG. 3 is a generalized operational flowchart for an exemplary embodiment of a distributed tangible user interface, according to one aspect of the present invention;

FIGS. 4A-B depict an operational diagram for certain primary functions of the processing unit of an exemplary embodiment of a tangible user interface manipulative, according to one aspect of the present invention;

FIG. 5 is an operational diagram for infrared handling by a processing unit of an exemplary embodiment of a tangible user interface manipulative, according to one aspect of the present invention;

FIG. 6 depicts exemplary embodiments of tangible user interface manipulatives recognizing each other and providing graphical feedback, according to one aspect of the present invention;

FIG. 7 is a flow chart depicting the operation of an exemplary embodiment wherein the tangible user interface manipulatives interact directly with each other, according to one aspect of the present invention;

FIG. 8 is a flow chart depicting the operation of the exemplary embodiment of FIG. 7, as designed for a specific application;

FIG. 9 depicts an exemplary implementation of tangible user interface manipulatives;

FIG. 10 depicts an exploded view of an exemplary implementation of a single tangible user interface manipulative;

FIG. 11 is a schematic of an exemplary implementation of the main processor and light-emitting diodes for a tangible user interface manipulative, according to one aspect of the present invention;

FIG. 12A is a schematic of an exemplary implementation of the accelerometer and associated signal conditioning circuits, along with the reset button for the processing unit, according to one aspect of the present invention;

FIG. 12B is a schematic of an exemplary implementation of the programming header for the processing unit, and the tactile actuation circuit for a tangible user interface manipulative, according to one aspect of the present invention;

FIGS. 13A-B are schematics of an exemplary implementation of the secondary processor, programming header for a secondary processor, and infrared communication modules and their associated circuitry for a tangible user interface manipulative, according to one aspect of the present invention;

FIG. 14 is a schematic of an exemplary implementation of the power circuitry for a tangible user interface manipulative, according to one aspect of the present invention;

FIGS. 15A-B depict a schematic of an exemplary implementation of the screen connection circuit for a tangible user interface manipulative, according to one aspect of the present invention;

FIG. 16 is a schematic of an exemplary implementation of the Bluetooth radio for a tangible user interface manipulative, according to one aspect of the present invention;

FIG. 17 is a schematic of an exemplary implementation of a charging circuit for a tangible user interface manipulative, according to one aspect of the present invention;

FIG. 18 depicts an exemplary “grouping” gestural language primitive using tangible user interface manipulatives, according to one aspect of the present invention;

FIG. 19 depicts an exemplary “yes/no” gestural language primitive using tangible user interface manipulatives, according to one aspect of the present invention;

FIG. 20 depicts an exemplary “clear” gestural language primitive using tangible user interface manipulatives, according to one aspect of the present invention;

FIG. 21 depicts an exemplary “thump” gestural language primitive using tangible user interface manipulatives, according to one aspect of the present invention; and

FIG. 22 depicts an exemplary “gather” gestural language primitive using tangible user interface manipulatives, according to one aspect of the present invention.

### DETAILED DESCRIPTION

The present invention is a platform that applies technology and methodology from wireless sensor networks to tangible user interfaces in order to yield new possibilities for human-computer interaction. The distributed tangible user interface, or Sensor Network User Interface (SNUI), of the present invention is a platform for physical interaction with information and media, comprising compact devices with sensing, display, and wireless communication capabilities. These devices can be physically manipulated as a group in order to permit a user to efficiently interact with digital information and media. The present invention permits people to interact with information and media in physical, natural ways that approach their interactions with physical objects in their everyday lives.

As used herein, the following terms expressly include, but are not to be limited to:

“Manipulative”, “Tangible user interface manipulative”, “Tangible user interface manipulative device”, and “TUI manipulative” all mean compact devices with sensing, display, and wireless communication capabilities that can be physically manipulated as a group in order to permit a user to interact with digital information and media in physical manner.

“Sensor network” means a wireless sensor network in which each node is physically independent, self-powered, and can communicate with its peers via a wireless radio.

“Sensor Network User Interface” and “SNUI” mean a system comprising a set of tangible user interface manipulatives that simultaneously provide the functionality of both a sensor network and a user interface. Although in “Experiences and Directions in pushpin computing” [Lifton, J., Broxton, M., Paradiso, J., Proceedings of the 4th international symposium on Information processing in sensor networks (2005)], Lifton et al. use the acronym SNUI to describe a separate interface allowing a user to interact with a sensor network, the term as used herein refers to a sensor network and user interface that are effectively congruent.

“Siftables” means a specific preferred embodiment of a tangible user interface manipulative, a set of such manipulatives, or a system employing the same.

The Sensor Network User Interface of the present invention is a distributed TUI in which a set of small physical manipulatives have sensing, wireless communication, and user-directed output capabilities. These devices can host a representation of a wide range of data and control parameters and can be physically manipulated as a group as a tangible interface to the data and applications employing the control parameters. They provide a generic interaction platform that combines the flexible graphical display capabilities of a GUI, the physicality of a TUI, and the capabilities of a sensor network. In contrast to TUIs that provide handles to a projected digital representation of data, an SNUI operator holds a representation of the data or parameter itself that can be perceived and altered directly. Though it increases system complexity for designers, the greater functional capabilities at the level of the individual interaction node minimize or eliminate requirements for external infrastructure such as a projector or an augmented tabletop surface. Also, an SNUI according to the present invention can be more easily reconfigured than the corresponding manipulatives of a single-purpose TUI built to utilize a particular sensing modality and form factor.

The component TUI manipulative devices are compact electronic devices with motion sensing, display, and wireless communication capabilities. One or more of such devices may be physically manipulated by a person in order to interact with digital information, media, and applications. A group of manipulatives can thus act in concert in order to form a physical, distributed, gesture-sensitive, human-computer interface. In the preferred embodiment, each TUI object is stand-alone (battery-powered and wireless) and does not require installed infrastructure such as specialized sensing surfaces, large displays, instrumented tables, or cameras in order to be used. Each manipulative has its own sensing, feedback, and communication abilities, effectively making a set of manipulatives a combination of a tangible interface and a sensor network. TUI manipulatives according to the preferred embodiment can sense their neighbors, allowing applications to utilize topological arrangement. They can also be used to implement any number of gestural interaction languages and HCI applications.

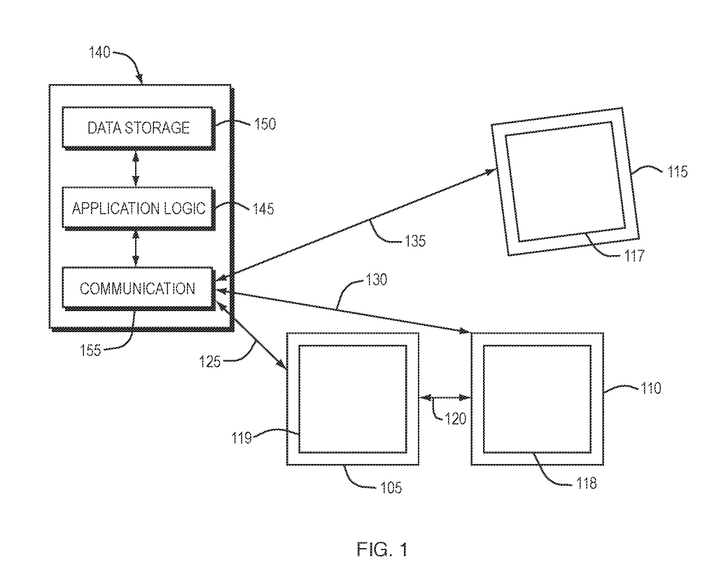

FIG. 1 is a block diagram of an exemplary a sensor-based distributed tangible user interface, according to one aspect of the present invention. In FIG. 1, tangible user interface manipulatives 105, 110, 115, having displays 117, 118, 119, communicate over wireless link 120 with each other and over wireless links 125, 130, 135 with computing device/hub 140. Wireless communication in the preferred embodiment includes, but is not limited to, manipulative-to-manipulative radio and infrared communication, and radio communication between manipulatives and a computing device/hub, such as, but not limited to, a PC or an application server, including, but not limited to, another tangible user interface manipulative device. Radio communication directly between manipulatives is particularly useful in certain circumstances, such as when a computing device is not in communication range. Computing device/hub 140 hosts management application 145, which manages generation of commands, retrieval of digital content from data storage 150, provision of content and commands to, and receipt of information from, manipulatives 105, 110, 115 using communications application/device 155 and links 125, 130, 135, and responds to information received from manipulatives 105, 110, 115.

Advantages and features of the preferred embodiment include, but are not limited to, provision for physical interaction with a collection of wirelessly-networked devices, the ability to manipulate data in 3-dimensions rather than being restricted to a 2-dimensional surface such as a screen, enablement of multi-person interaction, and provision for on-device input and output. Unlike other tabletop systems having collections of ‘pucks’ that interact with a larger display surface, the present invention provides input (motion sensing) and output (a graphical display) on the manipulative itself. The manipulatives are self-contained and mobile, being lightweight, portable, and battery-powered and they do not require any external sensing infrastructure, such as sensing tables or cameras).

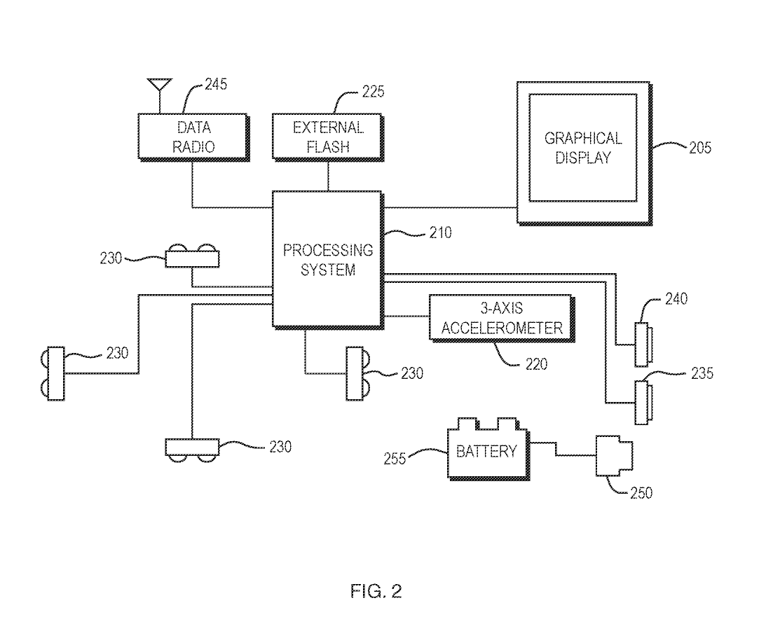

In one preferred embodiment, called “Siftables”, the TUI manipulatives are independent, compact devices with sensing, graphical display, and wireless communication capabilities. FIG. 2 is a system diagram of an exemplary embodiment of a “siftables” tangible user interface manipulative, according to one aspect of the present invention. As depicted in FIG. 2, each siftable device comprises graphical display 205, processing system 210, accelerometer 220 for inertial sensing, flash memory 225, four infrared communication modules 230 (one towards each direction), reset switch 235, power toggle 240, radio 245, power and charging port 250, and battery 255.

Graphical display 205, such as, but not limited to, a color screen, allows the TUI manipulative to display graphical content. The screen may be redrawn at high enough frame rates to create moving images or animations, or it may be updated more slowly. In the siftables implementation, processing system 210 controls screen 205, and it may provide it with vector drawing commands, bitmaps for display, or both. Processor 210 can also put display 205 into a low-power sleep state, can adjust the brightness and contrast, and can control a number of other parameters. Processing system 210 may be implemented in any of the many ways known in the art, including, but not limited to, as a single multiprocessor or as a multi-processor system. In the present siftables design, processing system 210 comprises a main processor for handling most tasks and a secondary processor for handling infrared communication with, and detection of, neighboring siftables.

In the siftable implementation, each siftable has flash memory module 225 that is separate from processing system 210. This memory can be written and read by processor 210, initiated either directly by a program running on the processor, or as a result of communication over the radio from a remote software program. Arbitrary data may be stored in this memory, such as images for display on the screen, variable names and associated values, samples from the accelerometer, program code, or any other data that an application may require. The microprocessor may also retrieve a sequence of images stored in this memory and display them sequentially on the screen, creating visual animations or movies.

The tangible user interface manipulative of the present invention is preferably powered on by the user. This is accomplished using button 240 in the siftables implementation, but it will be clear to one of skill in the art that any of the many means of powering on a small handheld device known in the art would be suitable including, but not limited to, causing power on to occur in response to a pre-specified gestural manipulations (such as, but not limited to, turning the device upside down for more than a prespecified time duration or shaking it) or in response to a wireless command from another device including, but not limited to, a computing device or another tangible user interface manipulative.

The tangible user interface manipulative is preferably powered by battery 255, but it will be clear to one of skill in the art that many other means of powering a small hand-held device are suitable for use in the invention including, but not limited to, the use of an on-board solar cell and associated charging system. Battery 255 is preferably rechargeable, but clearly may be any type of battery known in the art that can power the electronics and will fit into the allotted space. The “siftables” implementation is driven by small lithium-polymer batteries that may be recharged. The rechargeable battery can be recharged via charging port 250, which is a micro-USB socket attached to the main circuit board. A micro-USB cable is inserted into this socket, and the other end is inserted into a specialized charging printed circuit board that was designed for this purpose. It will be clear to one of skill in the art that alternatives, such as, but not limited to, inductive charging, may be advantageously employed to improve this characteristic so that frequent recharging is not required.

Sensing in the “siftables” implementation is accomplished using accelerometer 220 and four IrDA transceivers 230. When manipulated atop a flat surface, a siftable can sense its own motion in the plane of the surface, as well as the impacts it has with other objects. It can also sense the action of being lifted, tilted, or shaken, or vibrations resulting from the surface itself being impacted, such as, for instance, if the user raps their knuckles against the surface. The four IrDA transceivers are tuned for extremely short-range communication, on the order of 1 cm, and are used to detect neighboring manipulatives at close range. The sensed information can then be used by the siftable itself to modify its own behavior, or it can be shared wirelessly with other siftables or with a nearby computer. These sensing, graphical display, and wireless communication capabilities permit a set of siftables to behave as a single, coordinated interface to information and media.

It will be clear to one of skill in the art of the invention that the system details of the “siftables” implementation represent only one exemplary implementation of the present invention and that many alternate configurations are also within the scope of the present invention. For example, the particular sensing and wireless communication details, as well as the architecture of the software, could be implemented differently in order to achieve the same capabilities. For instance, infrared communication may be replaced with capacitive data transmission, or Bluetooth radios replaced with Zigbee compatible radios. However, despite any such variations in implementation details, the user experience and application possibilities remain similar. It is also possible to implement a richer set of input and output capabilities that can be used to implement new application scenarios, such as additional sensing modalities, such as, but not limited to, capacitive, and output capabilities, such as, but not limited to, auditory or tactile. On-siftable feedback may be provided by the graphical display, or by vibrational/haptic actuation, emission of sound, or other output capabilities that may be added to the siftable by an optional connected circuit.

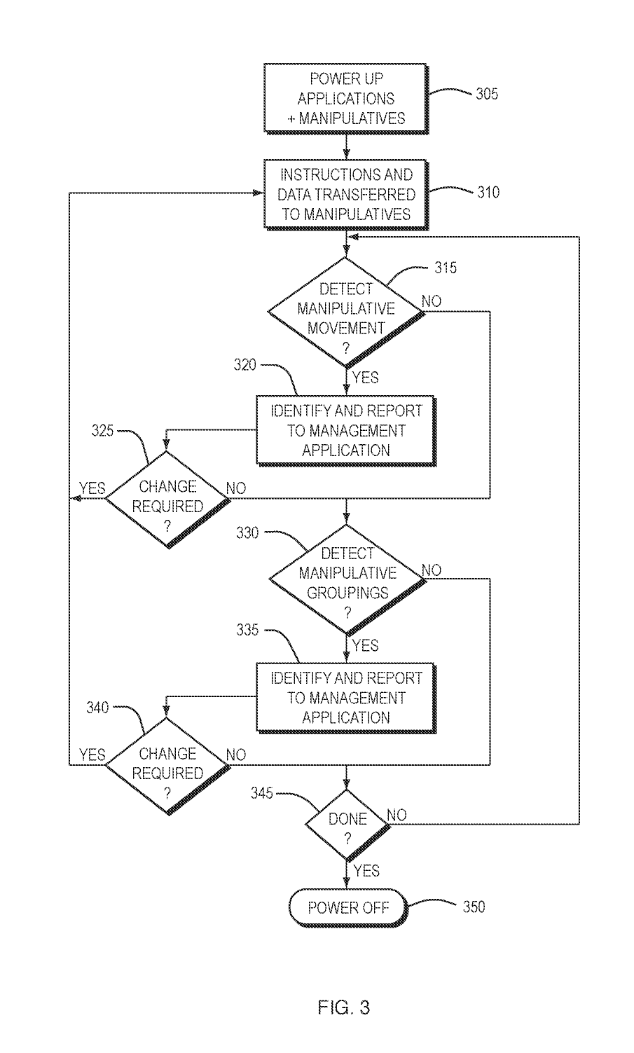

FIG. 3 is a generalized operational flowchart for an exemplary embodiment of a distributed tangible user interface, according to one aspect of the present invention. As shown in FIG. 3, after the applications and TUI manipulatives are powered up 305, relevant instructions and data are transferred 310 to the manipulatives. If movement of the manipulatives is detected 315, the movement is identified and reported 320 to the management application. If the detected movement requires a change 325 in the behavior of, or content displayed on, the manipulatives, new instructions or data are transferred 310. If a grouping of the manipulatives is detected 330, the grouping is identified and reported 335 to the content management application. If the detected grouping requires a change 340 behavior of, or content displayed on, the manipulatives, new instructions or data are transferred 310. When the user is finished 345, the TUI manipulatives are powered down 350.

For a typical data manipulation task, each TUI manipulative is populated, for example, via radio, with a representation of a single instance of the data to be manipulated, or with a control parameter than can be adjusted. The user's physical manipulations to the collection of manipulative devices are sensed and used as input to the system. Visual feedback during the task is presented to the user on the LCD display, and auditory feedback can be played by a nearby computer. In preferred embodiments, the TUI manipulatives have the ability to sense their arrangement with respect to each other using infrared communication capabilities, the ability to sense their own motion or the motion of the surface or object that they are in physical contact with using their accelerometer, and the ability to wirelessly communicate with each other, with a nearby computer, with a mobile phone, and/or with another electronic device.

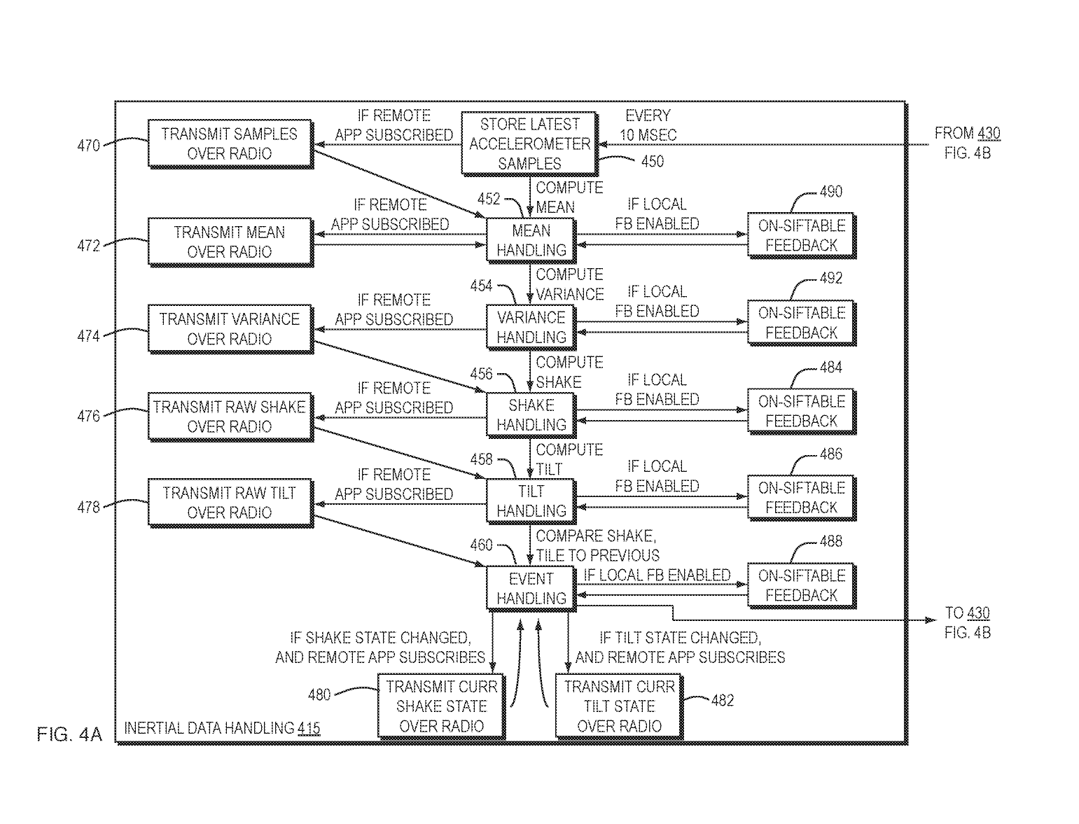

FIGS. 4A-B depict an operational diagram for some of the tasks performed by the processing unit of an exemplary embodiment of a “siftables” tangible user interface manipulative. In FIGS. 4A-B, four main process subsystems are shown: power and startup 405, message handling 410, inertial data handling 415, and neighbour handling 420. Each process subsystem comprises a number of individual functions. Within the functionality of power and startup subsystem 405, the siftable is powered on 425, initialized 427, and starts running 430. The main processor is responsible for periodically monitoring 432 the current battery status. If the battery level drops beneath a threshold, the main processor shuts the system power off 433, halting 435 the siftable. Message handling subsystem 410 parses 440 messages received via the siftable's radio link. If valid 442, the subsystem acts 445 on the message and/or replies. Inertial data handling subsystem 415 detects 450, processes 452, 454, 456, 458, 460 and communicates 470, 472, 474, 476, 478, 480, 482 the data created by user manipulation of the siftables, providing local feedback 484, 486, 488, 490, 492 if enabled. Similarly, neighbor handling subsystem 420 receives 494 messages, detects 495 and processes 496 the proximity of other siftables, and communicates 498 this proximity, providing local feedback 499, if enabled. Local feedback provision 484, 486, 488, 490, 492, 499 may employ any suitable feedback mechanism known in the art, including, but not limited to, display output of graphics or confirmatory messages, display flashing, vibration, or flashing of an on-board LED, if present, all of which are easily implementable to one of skill in the art through the provision of suitable hardware and/or microprocessor programming. For example, it might be advantageous to have the manipulative show a particular graphic or animation upon the initiation of shutdown, in order to confirm to the user that shutdown is in progress.

The run-time behavior of a manipulative may be determined by a program that is installed directly on the manipulative, by software running remotely on another computer that communicates with the manipulative wirelessly over the radio, or both. These models for application development represent distinct options for developers, and a given application may rely on a combination of local and remote code. Remote software may issue commands that alter the running behavior of the manipulative. Remote software can also ‘subscribe’ to receive periodically collected data (streams) or to detected changes in inertial or neighborhood state (events). It may also command the manipulative to start or stop broadcasting its ID over infrared, to start or stop listening for neighboring manipulatives, to display shapes, arbitrary graphics, or images retrieved from memory on the screen, to power off, or to take a number of other actions. Remote software may also be used to recognize gestures occurring across more than one manipulative, and may issue commands to the manipulative(s) in response to these gestures. The manipulative may generate a response to each command received from remote software, and may modify its internal state and current behavior accordingly. A software library may encapsulate the text-based language protocol, allowing for behavior specification to take the form of function calls in an application programming interface (API). The utility of such an API is that it creates the software abstraction of a software object by which a single manipulative may be controlled. Thus, monitoring and controlling a group of physical manipulative devices is accomplished in a manner very similar to monitoring and controlling a group of software objects, which enables straightforward application development.

Inertial Data Handling. On a given time interval (100 Hz in the current system), the current values from a three-axis accelerometer are read, and processed. The results may be handled by code on the manipulative or may be optionally reported over the radio. If remote software has ‘subscribed’ to receive raw accelerometer data, the raw values are transmitted over the radio. Using the newly captured values and a buffer of previous values, values such as running mean and variance are computed for each axis. If remote software has ‘subscribed’ to either of these values, the newly-computed values are transmitted over the radio. A current estimate of tilt and shaking state are computed. The current tilt and shake values are compared to the previously-measured values from the last analysis cycle, and if the current values are different from the previous ones and remote software has ‘subscribed’ to events for either of these values, the current state is transmitted over the radio.

In the present “siftables” implementation, a secondary processor is responsible for transmitting and receiving messages to and from nearby siftables using infrared communication. This duty may alternately be performed directly by the main processing unit, or may be performed by the main processing unit in conjunction with dedicated extra hardware. A nearby siftable that is close enough to be in infrared communication is considered a ‘neighbor’, and neighbors can be sensed in the four horizontal (North/South/East/West) directions surrounding a siftable. Transmitting and listening behavior may be turned on or off by the main processor. If a new neighbor arrives on a side, the stored representation of the current neighborhood is updated to reflect this addition and the updated state is immediately communicated to the main processor. The frequency of infrared messaging attempts is preferably high enough so that both arrivals and departures seem immediate to the user.

To transmit, the siftable periodically ‘pings’ an infrared pulse in each direction, and if a reply ‘ping’ from a neighboring siftable is received, it transmits a message to the neighbor, communicating the siftable's ID and from which side the message emanated. In order to reduce ‘jitter’ in the form of spurious arrival or departure messages to the main processor due to infrared message collisions or intermittent failures in infrared communication, a neighbor must not be heard from for a given amount of time, or a given number of communication cycles, before it is considered to have departed and its departure is noted by the processing unit. By this policy, new neighbor arrivals are communicated immediately, and departures take slightly longer to be confirmed and communicated. It will be clear to one of skill in the art that other modes of short-range data transmission may be used in place of infrared, and other communication schemes could be used in place of the particular “handshaking” and jitter-reduction algorithm used currently.

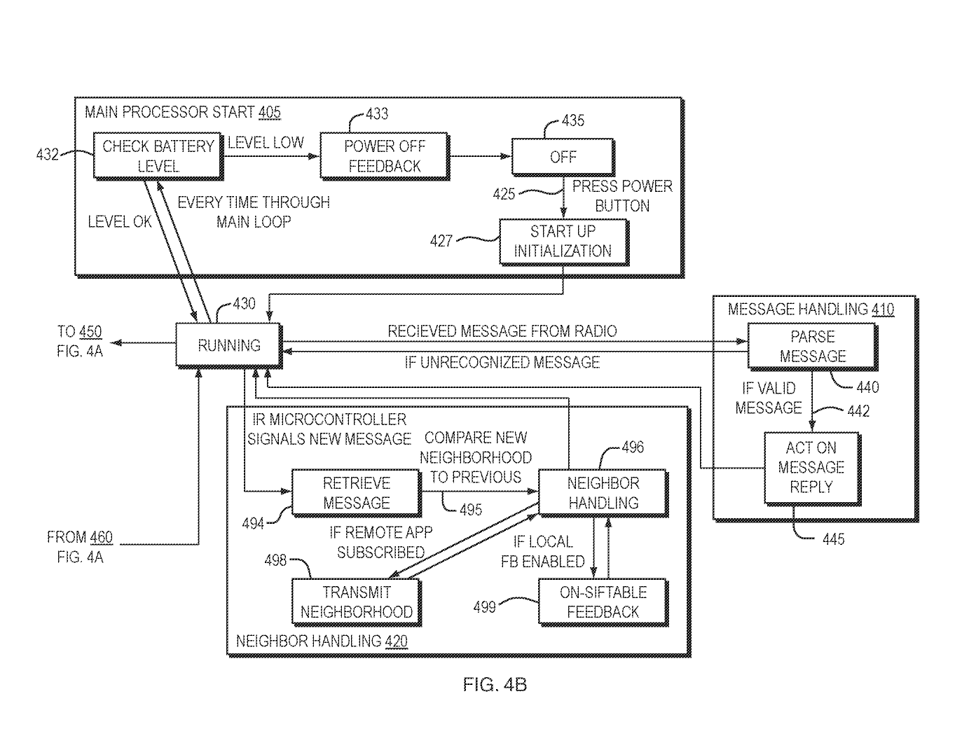

Neighbor communication behaviour may be changed as the program runs, including actions such as, but not limited to, enabling or disabling infrared listening or broadcast behaviour, updating broadcast information such as the siftable's numerical ID or broadcast period, querying information from a secondary processing unit, and/or commanding a secondary processing unit to perform some other duty that it is capable of, such as, but not limited to, user-directed feedback. FIG. 5 is an operational diagram for infrared handling by the processor of an exemplary embodiment of a “siftables” tangible user interface manipulative. In FIG. 5, when the siftable is powered up 505, the processor initializes 510 and enters run state 515, becoming ready to accept communications from neighboring siftables. In multiple processor embodiments, if a message is received 520 from another processor, the processor interprets it, performs any directed action, and replies 525. The processor listens for 530 and responds to 535 remote pings, identifies 540 its neighborhood of siftables, and may also optionally keep other processors informed 545 of the same. If broadcast is enabled 550, it also emits pings 555 searching for neighboring siftables, and responds 560 to any replies, then updating the current side 565.

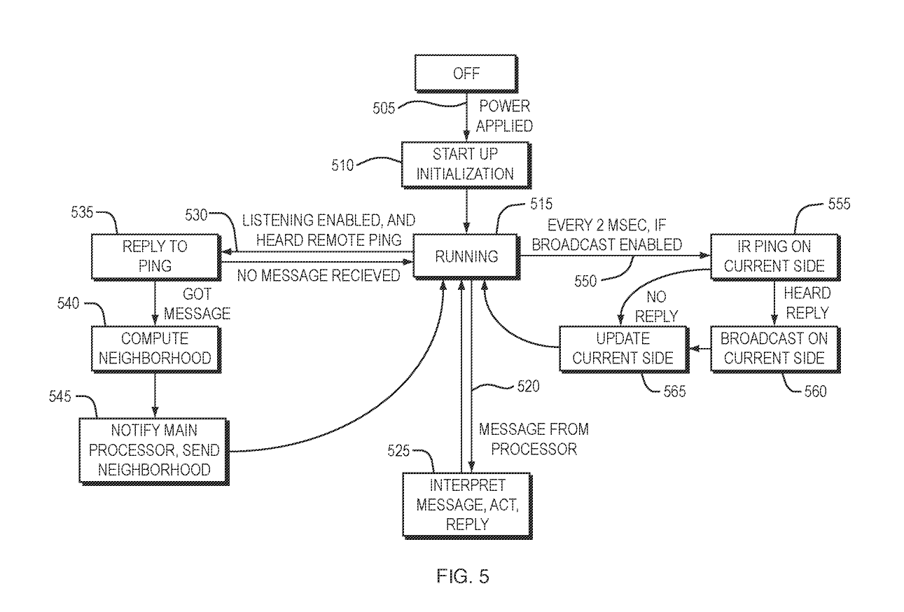

In preferred embodiments, the tangible user interface manipulative devices of a set have the ability to recognize and interact directly with each other. FIG. 6 depicts exemplary embodiments of tangible user interface manipulatives recognizing each other and providing graphical feedback to the user. In FIG. 6, manipulatives 610, 620, 630, and 640 recognize each other and together graphically present a flow diagram for pre-release product testing.

In some embodiments, derived movement parameters may be used only by the manipulatives themselves, rather than, or in addition to, being sent to a management application, or such parameters may not be utilized at all. In one exemplary embodiment of such a system, code programmed into the microcontroller handles the inputs such as sensing of neighbors and accelerometer data, and generates appropriate output, such as, for example, animating through sequences of images that are stored in the flash memory. This code utilizes the same basic subroutines that might alternatively be implemented by a remote program over the radio link, but in this embodiment the manipulative never forwards any data, nor receives any commands, from a remote machine.

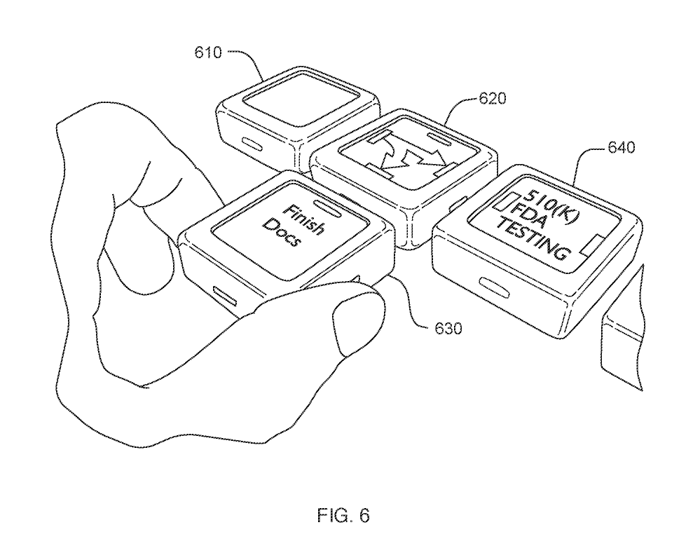

FIG. 7 is a flow chart depicting the operation of an exemplary preferred embodiment wherein the tangible user interface manipulatives interact directly with each other. As shown in FIG. 7, after power up 710, a manipulative enters 720 a response readiness state. Upon detection of a neighbour 730, the manipulative updates 740 its response behaviour or display. Similarly, upon detection of movement 750, the manipulative updates 760 its response behaviour or display. When an indication that the user is finished is received 770, or optionally after a predefined period of inactivity, the manipulative powers down 780.

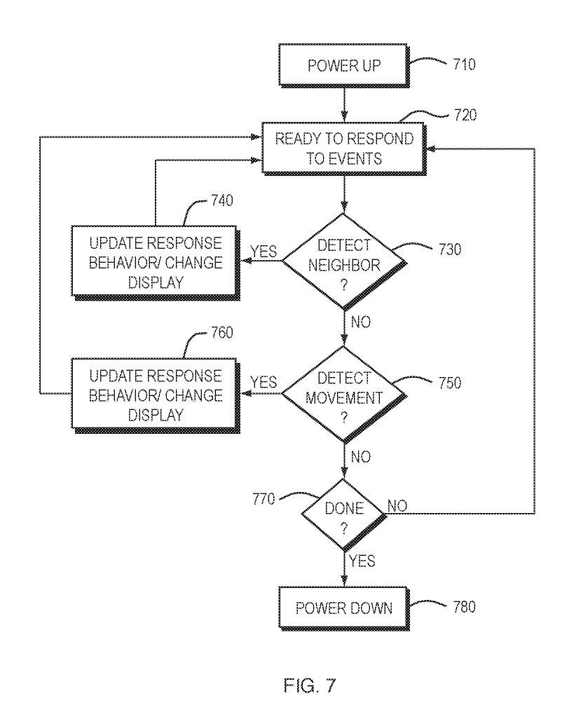

In one application that has been prototyped using the “siftables” implementation, there is no radio communication at all. Each siftable has a portrait of a person on it, and when two siftables are placed next to each other, the portraits animate to look towards each other. If more than one neighbor is detected at a time, the portrait animates to look around in a confused way. When they are moved away, the portraits animate to looking back forward again. If a siftable is shaken, the portrait animates to look around in a confused way, and if it is tilted, the portrait looks down, in the direction of gravity. Both neighbor- and motion-detection are used only on-board the siftables. FIG. 8 is a flow chart depicting the operation of this exemplary embodiment, which is a specific application of the process of FIG. 7. As shown in FIG. 8, after power up 810, a manipulative enters 820 a response readiness state wherein the face looks forward. Upon detection of a neighbour 830, the manipulative updates 840 its display so that the face looks toward the detected neighbor. Upon detection of movement 850, the manipulative updates 760 its display so that the face looks startled. When the user is finished 870, the manipulative powers down 880.

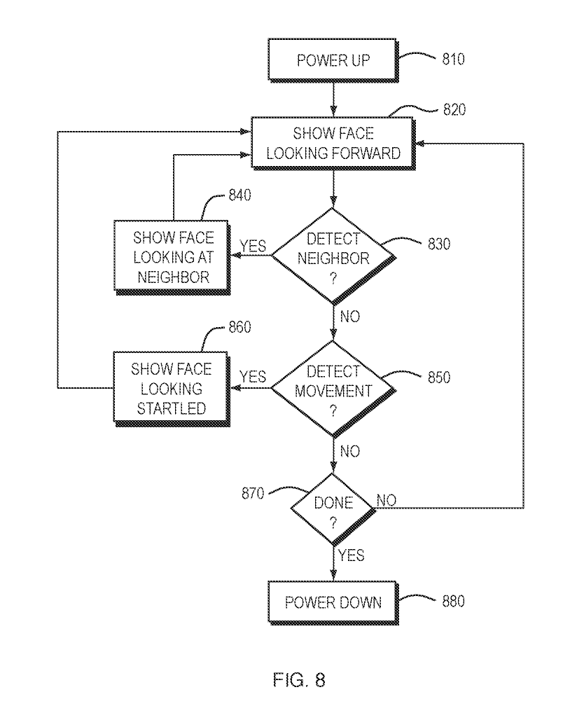

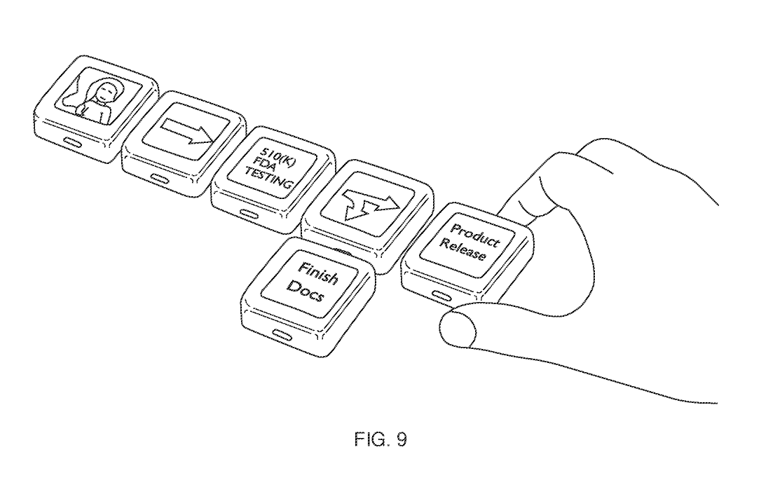

FIG. 9 depicts the exemplary “siftables” implementation of tangible user interface manipulatives, graphically presenting a product release flow diagram. The exemplary siftables manipulatives comprise a collection of compact tiles (36 mm×36 mm×10 mm), each with a color LCD screen, a 3-axis accelerometer, four IrDA infrared transceivers, an onboard rechargeable battery, and an RF radio. FIG. 10 depicts an exploded view of an exemplary implementation of a single “siftables” tangible user interface manipulative. Shown in FIG. 10 are front 1010 and back 1020 housings, LCD 1030, battery 1040, and main board 1050 with microcontroller 1060, accelerometer, IrDA transceivers, and wireless radio.

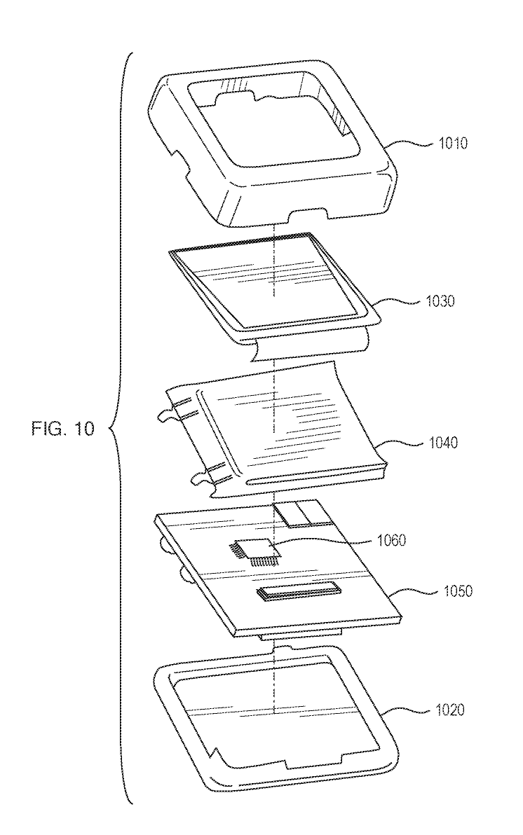

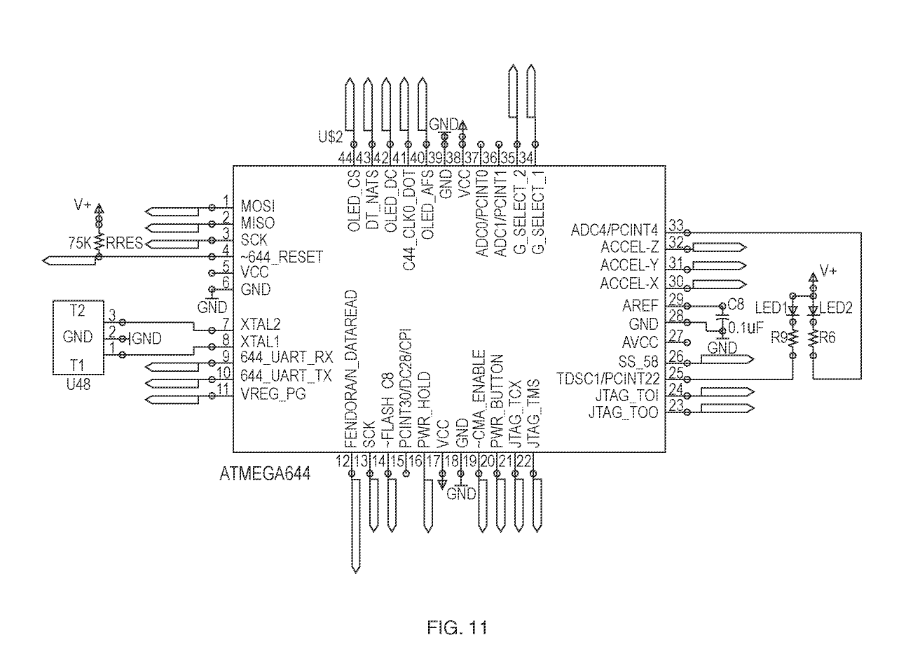

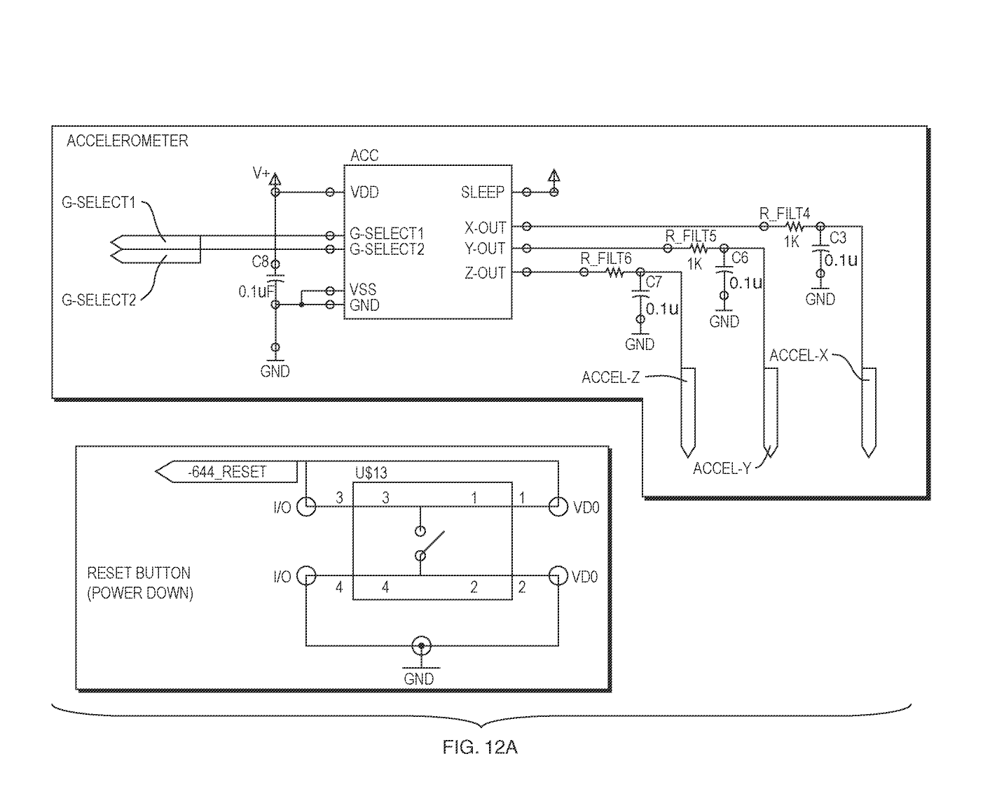

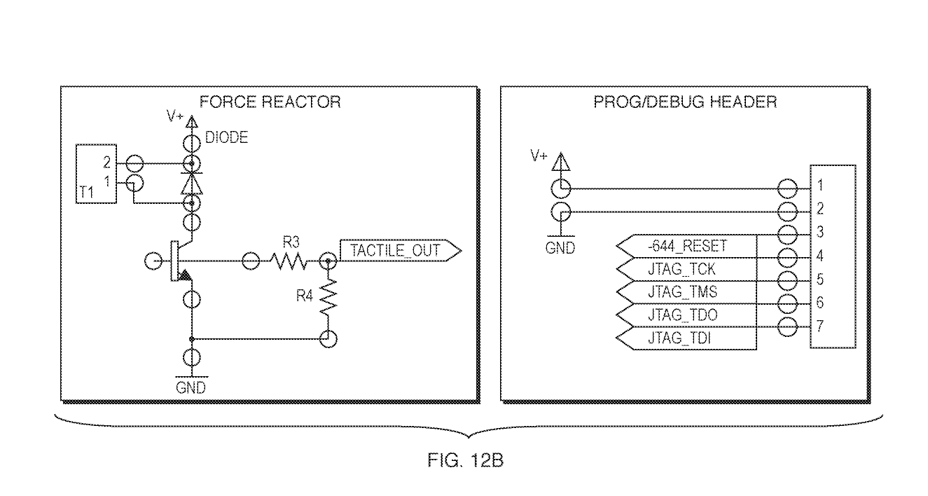

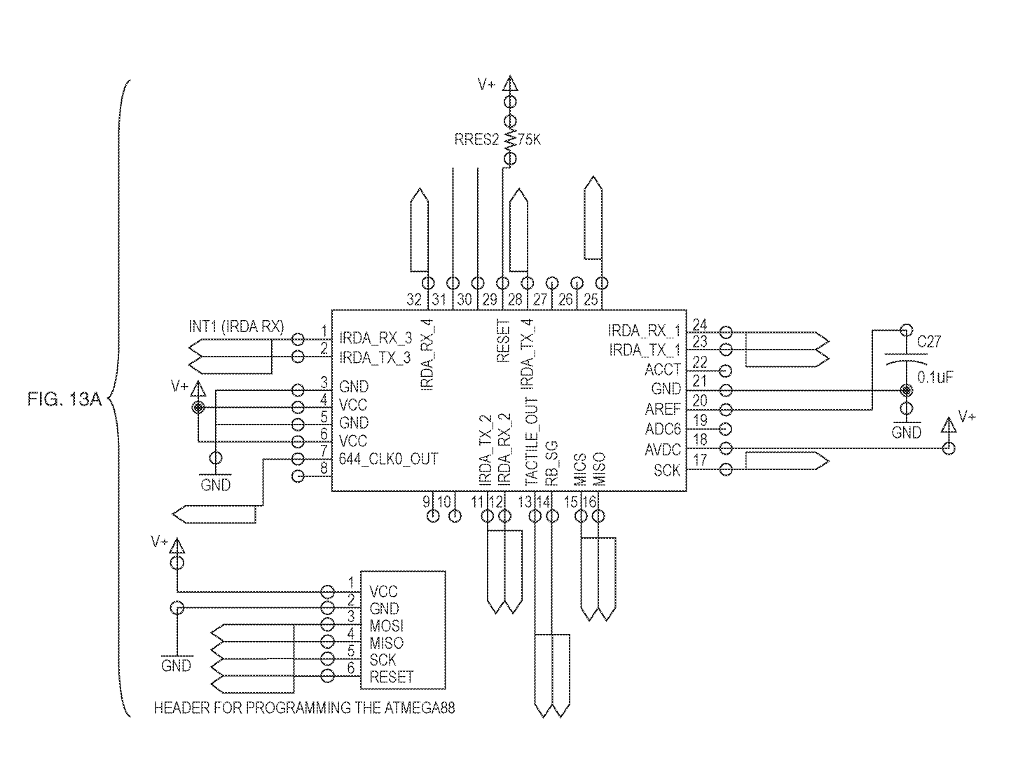

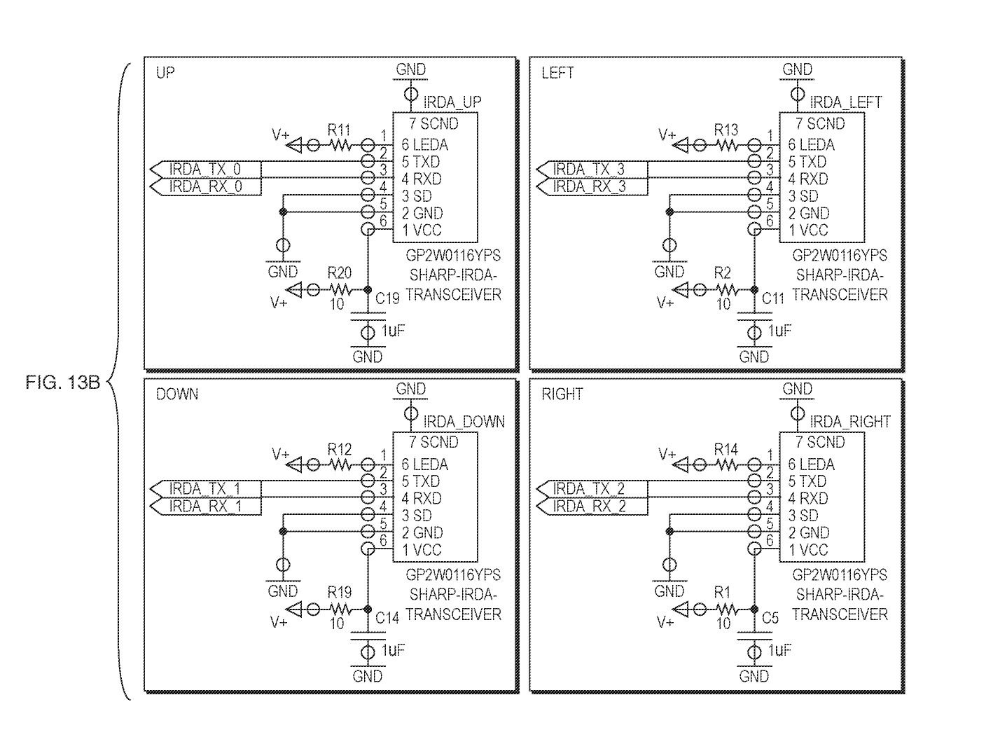

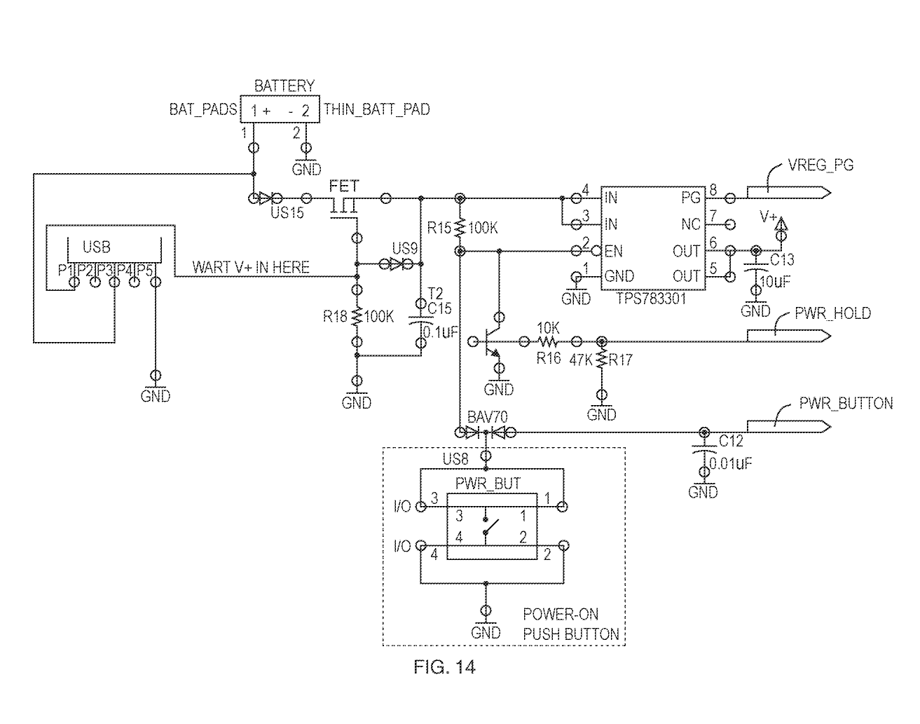

FIGS. 11-17 are schematic diagrams for the circuit of an exemplary implementation of a “siftables” tangible user interface manipulative, according to one aspect of the present invention. In particular, FIG. 11 is a schematic of an exemplary implementation of the main processor and light-emitting diodes, FIGS. 12A-B are schematics of an exemplary implementation of the accelerometer and associated signal conditioning circuits, reset button for the primary processor, programming header for the primary processor, and the tactile actuation circuit, and FIGS. 13A-B are schematics of an exemplary implementation of the secondary processor, programming header for the secondary processor, and infrared communication modules and their associated circuitry. FIG. 14 is a schematic of an exemplary implementation of the power circuitry, FIGS. 15A-B depict a schematic of an exemplary implementation of the screen connection circuit, FIG. 16 is a schematic of an exemplary implementation of the Bluetooth radio, and FIG. 17 is a schematic of an exemplary implementation of a charging board. Table 1 lists the details and manufacturers of the various system components employed in this exemplary implementation.

TABLE 1

| Count, part name | additional details | | Manufacturer | Manufacturer Address |
|---|---|---|---|---|
| 1 circuit board | v4 | | Advanced Circuits | 21101 E. 32nd Parkway, |
| | | | | Aurora, CO 80011 USA |
| 1 main microcontroller | ATMega644-20AU | | Atmel | 2325 Orchard Parkway, San |
| | | | | Jose, Ca 95131 USA |
| 2 resistors | 75K | | Rohm | 21, Saiin Mizosaki-cho, Ukyo- |
| | | | | ku, Kyoto 615-8585, JAPAN |
| 6 capacitors | 0.1 | uF | Panasonic ECG | One Panasonic Way |
| | | | | Secaucus, NJ 07094 USA |
| 1 ceramic resonator | 20 | MHz | ECS Inc. | 1105 S. Ridgeview Road |
| | | | | Olathe, KS 66062 USA |
| 2 pushbuttons | mom, normally-open | | Panasonic ECG | One Panasonic Way |
| | | | | Secaucus, NJ 07094 USA |
| 2 rows of header sockets | .05-inch, 7 (main) 6 | | Mill-Max | 190 Pine Hollow Road Oyster |
| | (hind), right-angle | | Manufacturing | Bay, NY 11771 USA |
| | thru-hole | | Corp. | |
| 1 flash memory chip | 64M | | Atmel | 2325 Orchard Parkway, San |
| | | | | Jose, Ca 95131 USA |
| 2 resistors | 47K | | Yageo | 15530 Wood-Red Rd. STE. |
| | | | | B100 Woodinville, WA 98072 |
| | | | | USA |
| 1 FET bus switch | SC70 | | Texas Instruments | 12500 TI Blvd. Dallas, TX |
| | | | | 75266-4136 USA |
| 4 resistors | 1M | | Yageo | 15530 Wood-Red Rd. STE. |
| | | | | B100 Woodinville, WA 98072 |
| | | | | USA |
| 1 3-axis accelerometer | | | Freescale | 7700 West Parmer Lane |
| | | | Semiconductor | Austin, Texas 78729 USA |
| 3 resistors | 1K | | Rohm | 21, Saiin Mizosaki-cho, Ukyo- |
| | | | | ku, Kyoto 615-8585, JAPAN |
| 1 boost converter | TPS61040 | | Texas Instruments | 12500 TI Blvd. Dallas, TX |
| | | | | 75266-4136 USA |
| 1 capacitor | 10 | uF | Panasonic ECG | One Panasonic Way |
| | | | | Secaucus, NJ 07094 USA |
| 1 inductor | 10 | uH | TDK | 901 Franklin Ave. Garden Cit |
| | | | | NY 11530-2933 USA |
| 3 schottky diodes | schottky | | Panasonic SSG | One Panasonic Way |
| | | | | Secaucus, NJ 07094 USA |
| 3 resistors | 100K | | Rohm | 21, Saiin Mizosaki-cho, Ukyo- |
| | | | | ku, Kyoto 615-8585, JAPAN |
| 1 capacitor | 100 | pF | Kemet | PO Box 5928, Greenville, |
| | | | | SC29681-6202 USA |
| 1 capacitor | 1 | uF | Panasonic ECG | One Panasonic Way |
| | | | | Secaucus, NJ 07094 |
| 1 LED | RED, 0805 | | Lite-On Inc. | 42000 Christy Street Fremont, |
| | | | | CA 94538 USA |
| 1 LED | GRN, 0805 | | Lite-On Inc. | 42000 Christy Street Fremont, |
| | | | | CA 94538 USA |
| 2 resistors | 510 | ohm | Yageo | 15530 Wood-Red Rd. STE. |
| | | | | B100 Woodinville, WA 98072 |
| | | | | USA |
| 1 secondary microcontroller | Atmega88 | | Atmel | 2325 Orchard Parkway, San |
| | | | | Jose, Ca 95131 USA |
| 4 IrDA style transceiver | | | Sharp | 22-22 Nagaike-cho, Abeno-ku |
| modules | | | Microelectronics | Osaka, 545-8522, JAPAN |
| 4 resistors | 5.1k | | Yageo | 15530 Wood-Red Rd. STE. |
| | | | | B100 Woodinville, WA 98072 |
| | | | | USA |
| 4 resistors | 10 | ohm | Yageo | 15530 Wood-Red Rd. STE. |
| | | | | B100 Woodinville, WA 98072 |
| | | | | USA |
| 4 capacitors | 1 | uF | Yageo | 15530 Wood-Red Rd. STE. |
| | | | | B100 Woodinville, WA 98072 |
| | | | | USA |
| 1 mosfet | P—CH trench | | NXP | High Tech Campus 60 5656 |
| | | | Semiconductor | AG Eindhoven, |
| | | | | NETHERLANDS |
| 1 diode switch | dual | | ON | 5005 East McDowell Road |
| | | | Semiconductor | Phoenix, AZ 85008 USA |
| 1 capacitor | 0.1 | uF | Panasonic ECG | One Panasonic Way |
| | | | | Secaucus, NJ 07094 USA |
| 1 transistor | NPN | | ON | 5005 East McDowell Road |
| | | | Semiconductor | Phoenix, AZ 85008 USA |
| 1 resistor | 10K | | Yageo | 15530 Wood-Red Rd. STE. |
| | | | | B100 Woodinville, WA 98072 |
| | | | | USA |
| 1 resistor | 47K | | Yageo | 15530 Wood-Red Rd. STE. |
| | | | | B100 Woodinville, WA 98072 |
| | | | | USA |
| 1 capacitor | .01 | uF | Yageo | 15530 Wood-Red Rd. STE. |
| | | | | B100 Woodinville, WA 98072 |
| | | | | USA |
| 1 voltage regulator | 3.3 V 500 MA LDO | | Texas Instruments | 12500 TI Blvd. Dallas, TX |
| | REG 8-SOIC | | | 75266-4136 USA |
| 1 capacitor | 10 uF (low ESR) | | Yageo | 15530 Wood-Red Rd. STE. |
| | | | | B100 Woodinville, WA 98072 |
| | | | | USA |
| 1 micro-usb connector | micro-usb socket | | Hirose Electric | 20400 Stevens Creek Blvd Ste |
| | | | | 250, Cupertino, CA USA |
| 1 capacitor | 10 | uF | Murata of North | 2200 Lake Park Dr, Smyrna, |
| | | | America | Georgia (GA), 30080-7604 |
| | | | | USA |
| 4 capacitors | 1 | uF | Panasonic ECG | One Panasonic Way |
| | | | | Secaucus, NJ 07094 USA |
| 1 capacitor | 4.7 | uF | Panasonic ECG | One Panasonic Way |
| | | | | Secaucus, NJ 07094 USA |
| 1 capacitor | 100 | uF | AVX Corporation | 801 17th Ave. S P.O. Box 86 |
| | | | | Myrtle Beach, SC 29578 USA |
| 1 zener diode | 3.6 | V | Comchip | 4115 Clipper Ct., Fremont, CA |
| | | | Technology | 94538 USA |
| 1 resistor | 51 | ohm | Rohm | 21, Saiin Mizosaki-cho, Ukyo- |
| | | | | ku, Kyoto 615-8585, JAPAN |
| 1 flat flex cable connector | CONN FPC 30POS | | FCI | 145 rue Yves le Coz 78035 |
| | .5 MM R/A SMD | | | Versailles Cedex FRANCE |
| | GOLD | | | |
| 1 radio module | Bluetooth | | Bluegiga | P.O. BOX 120, 02631 Espoo, |
| | | | Technologies | FINLAND |
| 1 top case | | | MIT Media Lab | 20 Ames St., Cambridge, MA |
| | | | | 02139 USA |
| 1 bottom case | | | MIT Media Lab | 20 Ames St., Cambridge, MA |
| | | | | 02139 USA |
| 1 OLED screen | 128 × 128 | | NEWTEC | 7F-1, No. 360, Beitun Rd., |
| | | | | Beitun District, Taichung City |
| | | | | TAIWAN R.O.C. |
| 1 battery | Lithium Polymer, | | GM Battery | Unit2310, Yijing Yun(Jiner |
| | 650 | mAh | | Liser), Block B1, Dashi Town |
| | | | | Panyu District, Guangzhou |
| | | | | City, PRC |
| 1 case (charger) | | | MIT Media Lab | 20 Ames St., Cambridge, MA |
| | | | | 02139 USA |
| 1 circuit board (charger) | | | Advanced Circuits | 21101 E. 32nd Parkway, |
| | | | | Aurora, CO 80011 USA |
| 1 LED (charger) | amber, 1206 | | Panasonic SSG | One Panasonic Way |
| | | | | Secaucus, NJ 07094 USA |
| 1 capacitor (charger) | 1 | uF | Panasonice ECG | One Panasonic Way |
| | | | | Secaucus, NJ 07094 USA |
| 1 resistor (charger) | 510 | ohm | Yageo | 15530 Wood-Red Rd. STE. |
| | | | | B100 Woodinville, WA 98072 |
| | | | | USA |
| 1 USB receptacle (charger) | | | Assmann | 1840 W. Drake Drive, Suite |
| | | | Electronics | 101, Tempe AZ, 85283, USA |
| 1 USB plug (charger) | | | Molex/Waldom | 2222 Wellington Court, Lisle, |
| | | | Electronics | 60532-1682 USA |
| 1 ferrite bead (charger) | 1 A, smd | | Steward | P.O. Box 510, Chattanooga |
| | | | | TN 37401-510, USA |
| 1 micro USB cable (charger) | | | Assmann | 1840 W. Drake Drive, Suite |
| | | | Electronics | 101, Tempe AZ, 85283, USA |
| 1 capacitor (charger) | 10 | nF | Panasonice ECG | One Panasonic Way |

| | | | |
|---|---|---|---|
| | | | Secaucus, NJ 07094 USA |
| 1 charging IC (charger) | MAX1555 | Maxim | 120 San Gabriel Drive, |

Rudimentary communication with the exemplary “siftables” implementation employs ASCII characters that may be typed on a keyboard. This language is not as efficient as it could be if binary opcodes and values were employed, but it makes it easier to interact with a siftable directly if needed, by typing characters by hand over a serial port type connection and viewing the immediate results. The decision to favor transparency over efficiency in the “siftables” implementation was made deliberately, in order to make debugging and programming for the “siftables” implementation easier, but it will be clear to one of ordinary skill in the art that other communication methodologies may be advantageously, and likely more efficiently, employed in the present invention. The Microsoft Windows-compatable RealTerm terminal program may be advantageously used to interact directly with the siftables, and any programming language with serial port or Bluetooth capabilities such as the Python programming language may be used to script application behavior for siftables.

The serial port parameters for connecting to a siftable over Bluetooth are: 115200,8,N,1. To initiate communication with a siftable of the current implementation, after opening the Bluetooth serial port, the message “1234\n” is sent to the siftable. If the siftable receives this message successfully, it replies with “ok 1234\r\n”. The general format of communication with a siftable is to send an ASCII command, terminated by an endline ‘\n’ character. The siftable replies to every message that it receives, and its reply is always terminated by “\r\n”. If the command is a query, and the query does not generate a valid reply, or is mis-typed, for instance, if “var get dave\n” is sent to a siftable and there is no variable named “dave”, the siftable will reply with an error message, such as: “error, no variable named dave\r\n”. If the siftable cannot parse the command that it was sent, for instance if a command is sent that doesn't make sense, like: “app delete atslot monkey\n”, the siftable will similarly reply with an error message. If the message sent to a siftable is not a query, for example if “acc smooth on\n” is sent to initiate low-pass filtering on the accelerometer data, the siftable will reply with “ok acc smooth on\r\n”.

Table 2 lists the ASCII Language commands that may be sent to a current-version siftable over the radio, and the reply that can be expected in response. This is not a final version of the language specification, but is rather a snapshot of the language used for the present “siftables” embodiment. It will be clear to one of skill in the art that commands may be added, removed, or modified with respect to this version.

TABLE 2

| | |
|---|---|
| 1234 | The magic message. Initiates communication with the siftable |
| | and must be sent first, before any other communication. |
| acc calibrate | calibrate the accelerometer, returns: |
| | “ok acc calibrate\r\n” |
| acc curr calib | reports the current accelerometer calibration values, as: |
| | “calib <x-cal> <y-cal> <z-cal>\r\n” |
| acc curr frame | reports a single accelerometer frame: |
| | “acc <x> <y> <z>\r\n” |
| acc curr tilt | reports the current tilt state, as: |
| | “tilt <x-tilt> <y-tilt> <z-tilt>\r\n” |
| acc curr shake | reports the current shake state, as: |
| | “shake <x-shake> <y-shake> <z-shake>\r\n” |
| acc curr var | reports the current variance values, as: |
| | “var <x-var> <y-var> <z-var>\r\n” |
| acc events tilt on/off | initiates/cancels reporting of tilt events, returns: |
| | “ok acc events tilt on/off\r\n” |
| acc events shake on/off | initiates/cancels reporting of shake events, returns: |
| | “ok acc events shake on/off\r\n” |
| acc stream var on/off | initiates/cancels streaming of variance values, returns: |
| | “ok acc stream var on/off\r\n” |
| acc stream raw on/off | initiates/cancels streaming of accelerometer data, returns: |
| | “ok acc stream raw on/off\r\n” |
| acc set shake threshold all <threshold> | sets the threshold of the shake detector for |
| | all axes. acceleration over this threshold |
| | registers as a shake, acceleration under it |
| | does not. values range from 0 to 2\hat{ }16, but |
| | practically a very hard shake might cross |
| | 6000 and gravity is about 60. |
| | “ok acc set shake threshold all <threshold> |
| | \r\n” |
| acc set shake threshold x <threshold> | sets the threshold of the shake detector for |
| | the x axis. |
| | “ok acc set shake threshold x <threshold> |
| | \r\n” |
| acc set shake threshold y <threshold> | sets the threshold of the shake detector for |
| | the y axis. |
| | “ok acc set shake threshold y <threshold> |
| | \r\n” |
| acc set shake threshold z <threshold> | sets the threshold of the shake detector for |
| | the z axis. |
| | “ok acc set shake threshold z <threshold> |
| | \r\n” |
| acc smooth on/off | initiates/cancels low-pass filtering of accelerometer data, |
| | returns: |
| | “ok acc smooth on/off\r\n” |
| app count | returns the number of installed applications: |
| | “app count <value>\r\n” |
| app exists withname <name> | returns 0 or 1, reporting whether there is an |
| | application with the given name: |
| | “app exists withname <name> <0/1>\r\n” |
| app exists atslot <slot> | returns 0 or 1, reporting whether there is an |
| | application at the given slot [1-15]: |
| | “app exists atslot <slot> <0/1>\r\n” |
| app get current name | returns the name of the current application: |
| | “app current name <name>\r\n” |
| app get name atslot <slot> | returns the name of the app at the given slot |
| | [1-15]: |
| | “app name atslot <slot> <name>\r\n” |
| app get slot withname <name> | returns the slot that the app with the given name is |
| | installed to, or 0 if no such application exists: |
| | “app slot withname <name> <slot>\r\n” |
| app get current slot | returns the slot of the current application, |
| | returns: |
| | “current slot <slot>\r\n” |
| app set current atslot <slot> | sets the current application to the given slot |
| | [1-15], returns: |
| | “ok app set currentr\n” |
| app set name atslot <slot> <name> | sets the name of the application at the given |
| | slot [1-15], returns: |
| | “ok app set name\r\n” |
| app set current withname <name> | sets the current application to the one with the |
| | given name, returns: |
| | “ok app set current withname <name>r\n” |
| app new withname <name> | creates a new application, with the given name, |
| | at the first free slot, returns: |
| | “ok app new withname <name> atslot <slot>r\n” |
| app new atslot <slot> withname <name> | creates a new application, with the given name, and |
| | at the given slot [1-15]. Overwrites any app that is |
| | there currently, returns: |
| | “ok app new atslot <slot> withname <name>\r\n” |
| app delete atslot <slot> | deletes the application at the given slot, returns: |
| | “ok app delete atslot <slot>\r\n” |
| app delete withname <name> | deletes the application with the given name, if it |
| | exists, returns: |
| | “ok app delete withname <name>\r\n” |
| app delete all | deletes all applications, returns: |
| | “ok app delete all\r\n” |
| app reset withname <name> | resets the application with the given name - that is, |
| | it deletes all variables and clears any claims on |
| | pages in memory, while leaving the application |
| | name in place, returns: |
| | “ok app reset withname <name>\r\n” |
| app restart current | restarts the current user-defined application, re- |
| | running the user-defined init function. |
| | “ok app restart current\r\n” |
| app reset atslot <slot> | resets the application at the given slot, returns: |
| | “ok app reset atslot <slot>\r\n” |
| color set both <r> <g> <b> | sets the current fill and outline colors, for drawing |
| | purposes. R and B should be in [0-31], inclusive, |
| | and G can be in [0-63], inclusive. |
| | “ok color setboth <r> <g> <b>\r\n” |
| color set fill <r> <g> <b> | sets the current fill color, for drawing purposes. R |
| | and B should be in [0-31], inclusive, and G can be |
| | in [0-63], inclusive, |
| | “ok color set fill <r> <g> <b>\r\n” |
| color set outline <r> <g> <b> | sets the current outilne color, for drawing purposes. |
| | R and G should be in [0-7], inclusive, and B can be |
| | in [0-3], inclusive (8-bit color mode), |
| | “ok color set outline <r> <g> <b>\r\n” |
| color set depth <depth> | sets color depth, which affects image uploading and |
| | displaying, but not shape drawing, depth can |
| | currently be 8 or 16. images are indexed based on |
| | color depth because they take up twice as much |
| | space in 16 bit mode, |
| | “ok color set depth <depth>\r\n” |
| draw testpattern | draws the test pattern to the screen, returns: |
| | “ok draw testpattern\r\n” |
| draw neighbormarker <side> | draws a neighbor marker at the given side [0-3], |
| | returns: |
| | “ok draw neighbormarker <side>\r\n” |
| draw allborder | draws a generic border around the entire perimeter, |
| | using the current color, returns |
| | “ok draw allborder\r\n” |
| draw border <side> | draws a generic border on the given side [0-3], |
| | returns: |
| | “ok draw border <side>\r\n” |
| draw circle <x> <y> <rad> | draws a circle at the given row <x> and column |
| | <y>, with radius <rad>, using the current colors. |
| draw rect <x> <y> <w> <h> | draws a rectangle at the given row <x> and column |
| | <y>, with width <w> and height <h>, using the |
| | current colors. |
| draw line <x1> <y1> <x2> <y2> | draws a line starting at the given row <x1> and |
| | column <y1>, ending at the given row <x2> and |
| | column <y2>, using the current fill color. |
| draw pixel <x> <y> | draws a pixel at the given row <x> and column |
| | <y> using the current fill color. |
| echo on | turns on terminal character echo-ing (off by |
| | default), returns: |
| | “ok echo on\r\n” |
| echo off | turns off terminal character echo-ing (default), |
| | returns: |
| | “ok echo off\r\n” |
| flash getstatusbyte | (for debugging) returns the status byte of the flash |
| | memory chip, as: |
| | “flash statusbyte <byte>\r\n” |
| flash setbinary | (for debugging) sets the flash memory to use |
| | power-of-two page sizes, so that each page is 1024 |
| | bytes, this should already be the case, so you |
| | shouldn't need to use this command, returns: |
| | “ok flash setbinary\r\n” |
| handler acc data on/off | turns the siftable-internal (firmware, written-in-C) |
| | accelerometer data handler on or off. |
| | “ok handler acc data <on/off>\r\n” |
| handler acc tilt events on/off | turns the siftable-internal (firmware, written-in-C) |
| | tilt event handler on or off. |
| | “ok handler tilt events <on/off>\r\n” |
| handler acc shake events on/off | turns the siftable-internal (firmware, written-in-C) |
| | accelerometer shake events handler on or off. |
| | “ok handler tilt events <on/off>\r\n” |
| handler neighbor events on/off | turns the siftable-internal (firmware, written-in-C) |
| | neighbor events handler on or off. |
| | “ok handler neighbor events <on/off>\r\n” |
| handler 100 hz on/off | turns the given siftable-internal (firmware, written- |
| | in-C) timer-based handlers on or off. |
| | “ok handler <N>hz <on/off>\r\n” |
| handler 50 hz on/off | “” |
| handler 25 hz on/off | “” |
| handler 10 hz on/off | “” |
| handler 5 hz on/off | “” |
| handler 1 hz on/off | “” |
| id get | returns the current ID [1-255]. |
| | “id <id>\r\n” |
| id set <id> | sets the siftable's ID.The ID can be [1-255] |
| | “ok id set <id>\r\n” |
| image animate <s> to <f> fps <r> | animates through a sequence of images stored in |
| | the siftable's flash memory, beginning at frame <s> |
| | and finishing at frame <f>, at a frame-per-second |
| | rate given by <r> (NOTE: <fps> is currently |
| | ignored, not yet implemented) |
| | “ok image animate\r\n” |
| image display <idx> | displays the image at index <idx>, for the current |
| | application. indexing changes based on color depth. |
| | 16 bit mode image #(n) takes up 8 bit mode image |
| | #(2n) and #(2n + 1). 16 bit image #n DOES NOT |
| | EQUAL 8 bit image #n. |
| | “ok image display <idx>\r\n” |
| image set current <idx> | sets the current background image. This image will |
| | be displayed underneath any neighbor markers or |
| | borders that are displayed. SEE NOTE UNDER |
| | IMAGE DISPLAY! The index is with respect to the |
| | current application, returns: |
| | “ok image set current <idx>\r\n” |
| image stream | initiates streaming an image to the siftable for |
| | immediate display. this is how can you can send an |
| | image to the siftable for temporary display, but |
| | without writing it to the flash memory. SEE NOTE |
| | UNDER IMAGE DISPLAY! siftable replies with “ok |
| | image stream\r\n”. then expects the bytes of the |
| | image to start coming across, the siftable will reply |
| | with ‘R’ after receiving each row. |
| | “ok image stream\r\n” |
| image upload <idx> | initiates uploading an image to the siftables, writing |
| | it to the flash memory. siftable replies with “ok |
| | image upload\r\n”, then expects the bytes of the |
| | image to start coming across, the number of bytes |
| | the siftable expects depends on the color depth. the |
| | siftable will reply with ‘R’ immediately, and after |
| | receiving each row. |
| | “ok image upload\r\n” |
| led red on | turns the red LED on, returns: |
| | “ok led red on\r\n” |
| led red off | turns the red LED off, returns: |
| | “ok led red off\r\n” |
| led green on | turns the green LED on, returns: |
| | “ok led green on\r\n” |
| led green off | turns the green LED off, returns: |
| | “ok led green off\r\n” |
| led red toggle | toggles the red LED, returns: |
| | “ok led red toggle\r\n” |
| led green toggle | toggles the green LED, returns: |
| | “ok led green toggle\r\n” |
| neighbor snapshot | returns a snapshot of the neighborhood - that is, |
| | which other siftables are nearby. (TODO: specify |
| | format of report) |
| | “neighbor snapshot <n0-ID> <n0-side> <n1-ID> . . . |
| | \r\n” |
| neighbor events on | turns on neighbor reporting, so that whenever the |
| | neighborhood changes a message will be generated. |
| | “ok neighbor report on\r\n” |
| neighbor events off | turns off neighbor reporting |
| | “ok neighbor report off\r\n” |
| neighbor broadcast on | turns on outgoing IRDA messages to neighbors |
| | “ok neighbor broadcast on\r\n” |
| neighbor broadcast off | turns off outgoing IRDA messages to neighbors |
| | “ok neighbor broadcast off\r\n” |
| neighbor markers on | turns on graphical neighbor markers |
| | “ok neighbor markers on\r\n” |
| neighbor markers off | turns off graphical neighbor markers |
| | “ok neighbor markers off\r\n” |
| power off | turns the siftable's power off, halting siftable and |
| | severing your Bluetooth connection to the device, |
| | “ok power off\r\n” |
| power status | returns the state of the power good pin. |
| | “power status <0/1>\r\n” |
| power shutdown withdelay <val> | turns the siftable's power off after a given delay (in |
| | seconds). |
| | “ok power shutdown withdelay\r\n” |
| power shutdown cancel | cancels a delayed power shutdown |
| | “ok power shutdown cancel\r\n” |
| ping | Use this to find out if the siftable is accepting |
| | commands. pings the siftable, which replies as: |
| | “ok ping\r\n” |
| screen bright max | sets the screen to maximum brightness, returns: |
| | “ok screen bright max\r\n” |
| screen bright min | sets the screen to minimum brightness |
| | “ok screen bright min\r\n” |
| screen bright val <val> | sets the screen to an arbitrary brightness [0-255] |
| | “ok screen bright val <val>\r\n” |
| screen sleep | puts the screen into low-power sleep mode |
| | “ok screen sleep\r\n” |
| screen awake | puts the screen into awake mode |
| | “ok screen awake\r\n” |
| screen clear | clears the screen (black) |
| | “ok screen clear\r\n” |
| var set <name> <value> | sets the value of the variable named <name> with |
| | the given value, for the current application. if no |
| | variable by that name exists in the current |
| | application, it is first created. <name> can be at |
| | most 31 characters long, and cannot contain |
| | spaces. <value> is stored as an unsigned 16-bit |
| | value, so it can range in [0-65535]. If you need to |
| | store more than 16 bits, use more than one |
| | variable, returns: |
| | “ok var set <name> <val>\r\n” |
| var get <name> | returns the value associated with the given variable |
| | name, as: |
| | “var <name> <value>\r\n” |
| var delete <name> | removes the variable with the given name, as well |
| | as its value, returns: |
| | “ok var delete <name>\r\n” |
| var count | returns the number of variables installed for the |
| | current application, |
| | “var count <count>\r\n” |
| var loc nextfree | (for debugging) returns the byte index of the next |
| | free variable location in the current application |
| | page, returns: |
| | “var loc nextfree <idx>\r\n” |
| var report <idx> | (for debugging) returns the name and value of the |
| | variable at index <idx>, formatted as: |
| | “var report <idx> <name> <value>\r\n”. |
| var dumpraw | (for extreme debugging) prints the entire page of |
| | memory associated with this application, byte-for- |
| | byte, first reports: |
| | “ok var dumpraw\r\n” |

A software library that encapsulates the text-based language protocol for the “siftables” implementation, allowing for behavior specification to take the form of function calls in an application programming interface (API), has been implemented in the Python programming language, and features a nearly one-to-one correspondence between the existing language commands and the corresponding functions that it provides. Table 3 presents the Siftable Python API Listing. It will be clear to one of skill in the art that this program listing is exemplary, and that many other similar protocols, languages, etc might be advantageously employed in an implementation of the present invention.

TABLE 3
_{——}init_{——}(self, conn=None, bt_name=‘’, bt_id=‘’, serial_port=‘’,

using_server=False)

siftable constructor
if a connection is passed in, the constructor will use that connection
if a bt_name is passed in, the constructor will attempt to make a connection to
that name using a pybluez RFCOMM connection. (Windows/Linux only)

acc_calibrate(self)

calibrates the accelerometer. note: this takes more than a second

acc_curr_calib(self)

returns the current accelerometer calibration values

acc_curr_frame(self)

returns the current raw accelerometer data frame. format is [x,y,z], where
each value is on [0-255]

acc_curr_shake(self)

returns the current shake state. format is [x,y,z], where each
value is 0 (not shaking) or 1 (shaking)

acc_curr_tilt(self)

returns the current tilt state. format is [x,y,z], where the value is:
on x: 2 is tilted left, 1 is neutral, and 0 is tilted right
on y: 0 is tilted up, 1 is neutral, 2 is tilted down
on z: 1 is right-side up, 0 is upside-down
note: accelerometer must be calibrated before this command will work.
see acc_calibrate

acc_curr_var(self)

returns the current accelerometer variance frame. format is [x,y,z], where
each value is on [0-255]. note: this may be a bug, since variance values are
16-bit unsigned

acc_events_shake(self, command)

turns reporting of shake events on or off. you should have a handler installed
before turning this on, or the events will be discarded. (takes True/False)

acc_events_tilt(self, command)

turns reporting of tilt events on or off. you should have a handler installed
before turning this on, or the events will be discarded. (takes True/False)

acc_get_sensitivity(self)

Sets the sensitivity of the sensitivity by altering the gain on the input
stage of the device.
The values that will be returned by acc_get_sensitivity are:
‘1.5g’
‘2g’
‘4g’
‘6g’

acc_set_sensitivity(self, sensitivity)

these are the values to feed to acc_set_sensitivity
siftable.Siftable.ACC_SENSITIVITY_1p5G
siftable.Siftable.ACC_SENSITIVITY_{——}2G
siftable.Siftable.ACC_SENSITIVITY_{——}4G
siftable.Siftable.ACC_SENSITIVITY_{——}6G

acc_set_shake_threshold_all(self, threshold)

sets the shake threshold for the x, y, and z axes to the same value, on
[0-65535]

acc_set_shake_threshold_x(self, threshold)

sets the shake threshold for the x axis, on [0-65535]

acc_set_shake_threshold_y(self, threshold)

sets the shake threshold for the y axis, on [0-65535]

acc_set_shake_threshold_z(self, threshold)

sets the shake threshold for the z axis, on [0-65535]

acc_smooth(self, command)

turns on smoothing for the accelerometer data, which is implemented by a
running-average style low pass filter. (takes True/False)

acc_stream(self, command)

turns on streaming of the raw accelerometer data. you should have a handler
installed before turning this on, or the frames will be discarded.
(takes True/False)

acc_stream_var(self, command)

turns on streaming of the raw variance data. you should have a handler
installed before turning this on, or the frames will be discarded.
(takes True/False)

app_count(self)

returns the number of apps in the flash

app_delete_all(self)

deletes all apps from the flash

app_delete_atslot(self, slot)

deletes the app at the given slot in the flash

app_delete_withname(self, name)

deletes the app with the given name from the flash

app_exists_atslot(self, slot)

returns 1 if an app exists at the given slot, 0 otherwise

app_exists_withname(self, name)

returns 1 if an app exists with the given name, 0 otherwise

app_get_current_name(self)

retrns the name of the currently selected application

app_get_current_slot(self)

returns the slot of the currently selected app

app_get_name_atslot(self, slot)

returns the name of the app at the given slot

app_get_slot_withname(self, name)

returns the slot where the app with the given name resides

app_new_atslot_withname(self, slot, name)

creates a new app in the flash, at the given slot, and with the given name

app_new_withname(self, name)

creates a new app in the flash, at the next available slot, with the given name

app_reset_withname(self, name)

restarts the application with the given name

app_restart_atslot(self, slot)

restarts the application at the given slot

app_restart_current(self)

restarts the current application, re-reading any initialization information
from the flash

app_set_current_atslot(self, slot)

sets the current app to be the one at the given slot

app_set_current_withname(self, name)

sets the current app to be the one with the given name

app_set_name_atslot(self, slot, name)

sets the name of the app at the given slot to the given name

close(self)

# attempts to shut down the Bluetooth connection to the Siftable

color_get_depth(self)

returns the current color depth being used for graphics

color_set_both(self, r, g, b)

sets both outline and fill colors to the same value. r, g, and b are on [0-255]

color_set_depth(self, depth)

sets color depth for graphics. allowed values are 8 and 16

color_set_fill(self, r, g, b)

sets the fill color for shape drawing. r, g, and b are on [0-255]

color_set_outline(self, r, g, b)

sets the outline color for shape drawing. r, g, and b are on [0-255]

draw_allborder(self)

draws a border all the way around the siftable's screen, using the
current colors

draw_border(self, side)

draws a rectangle that spans the given side

draw_circle(self, col, row, radius)

draws a circle at the given row and col, with the given radius

draw_line(self, col1, row1, col2, row2)

draws a line. note: col2 must be greater than col1, and row2 must be
greater than row1

draw_neighbormarker(self, side)

draws a simple marker in the center of the given side, useful for debugging,
when you want to show that the siftable is aware of a given neighbor

draw_pixel(self, col, row)

draws a single pixel. note: currently uses the draw_rect routine internally -
not efficient

draw_rect(self, col1, row1, col2, row2)

draws a rectangle. note: col2 must be greater than col1, and row2 must

be greater than row1
draw_testpattern(self)

draws a simple test pattern to the screen

echo(self, command)

toggles character echo behavior for terminal access. (takes True/False)

flash_getstatusbyte(self)

returns the current status byte of the off-board flash memory

flash_setbinary(self)

sets the off-board flash memory to use a power-of-two page size. all siftables
should be configured with this option already, so you should not need to
use this command

handler_100hz(self, command)

turns the internal (C firmware API) handler on the 100hz interval on or off.
(takes True/False)

handler_10hz(self, command)

turns the internal (C firmware API) handler on the 10hz interval on or off.
(takes True/False)

handler_1hz(self, command)

turns the internal (C firmware API) handler on the 1hz interval on or off.
(takes True/False)

handler_25hz(self, command)

turns the internal (C firmware API) handler on the 25hz interval on or off.
(takes True/False)

handler_50hz(self, command)

turns the internal (C firmware API) handler on the50hz interval on or off.
(takes True/False)

handler_5hz(self, command)

turns the internal (C firmware API) handler on the 5hz interval on or off.
(takes True/False)

handler_acc_data(self, command)

turns the internal (C firmware API) handler for accelerometer data on or off.
(takes True/False)

handler_acc_shake_events(self, command)

turns the internal (C firmware API) handler for shake events on or off.
(takes True/False)

handler_acc_tilt_events(self, command)

turns the internal (C firmware API) handler for tilt events on or off.
(takes True/False)

handler_neighbor_events(self, command)

turns the internal (C firmware API) handler for neighbor events on or off.
(takes True/False)

id_get(self)

returns the numeric ID of the siftable

id_set(self, new_id)

sets the ID of a siftable to a new value. note: ids can be in the range of
[0-255]
all existing siftables have an ID already, so you should not need to do this.
note also that this will NOT change the Bluetooth name of the sift to reflect
the new ID. you should not need to use this function!

image_animate(self, start_idx, end_idx, delay_ms=0)

animates through images stored in the flash memory, from start_idx
to end_idx, with a short delay between each, note: delay_ms is
currently ignored

image_display(self, idx)

instructs the siftable to display the image at the given index. note that
image indexing depends on the current color depth. we recommend that
you stick to a single color depth for images stored on a given siftable

image_set_current(self, idx)

sets the ‘current image’ to the given index.
note: this is only used with neighbor-marking behavior

image_upload(self, im, idx, force=False)

uploads the passed-in image to the given index. note that
image indexing depends on the current color depth. we recommend that
you stick to a single color depth for images
stored on a given siftable. to upload images to slots 0, 1, or 2 you have to pass
force=True, since these are system-reserved areas of the flash

install_listener_neighbor_events(self, listener)

install a listener function for neighbor events

install_listener_raw_acc_data(self, listener)

install a listener function for raw accelerometer data frames

install_listener_raw_var_data(self, listener)

install a listener function for accelerometer variance data frames

install_listener_shake_events(self, listener)

install a listener function for shake events

install_listener_tilt_events(self, listener)

install a listener function for tilt events

led_green(self, command)

turn the green LED on or off. (takes True/False). on the current siftables,
the LEDs are not visible, so this command is not very useful anymore.

led_green_toggle(self)

Toggles the green LED. on the current siftables, the LEDs are not
visible, so this command is not very useful anymore

led_red(self, command)

turn the red LED on or off. (takes True/False). on the current siftables,
the LEDs are not visible, so this command is not very useful anymore.

led_red_toggle(self)

Toggles the red LED. on the current siftables, the LEDs are not
visible, so this command is not very useful anymore

neighbor_broadcast(self, command)

turns broadcasting of this siftable's ID and side on/off (takes: True/False)

neighbor_events(self, command)

turns event-reporting for neighborhood changes on or off (takes: True/False)

neighbor_markers(self, command)

turns neighbor markers on or off (takes: True/False)
note: neighbor-marking behavior utilizes the current image as a background

neighbor_snapshot(self)

returns an array representing the current neighborhood, as tracked by
the siftable.
the format of this array is: [neighbor_TOP_id, neighbor_TOP_side, ...]
the order is TOP, LEFT, RIGHT, BOTTOM
a sample return value is: [0,0,25,1,0,0,42,0]
meaning that: siftable 25 is to the left, and its left side is facing, and
siftable 42 is to the bottom, and its top side is facing

ping(self)

just lets you know that the sift is ok. returns: ‘ping’

power_off(self)

immediately powers off the siftable. note: use of this function typically
makes it difficult to detach cleanly from the Bluetooth radio.
see power_shutdown_withdelay for a better way to do this

power_shutdown_cancel(self)

cancels a pending power_shutdown_withdelay command

power_shutdown_withdelay(self, delay)

shuts down after the given number of seconds. use this to allow your code to
cleanly disconnect from the siftable before it shuts off

power_status(self)

returns the status of the power_good line on the main micro. if you get a
reply, the value will be 1

remove_listener_neighbor_events(self)

remove the listener function for tilt events

remove_listener_raw_acc_data(self)

remove the current listener function for raw accelerometer data frames

remove_listener_raw_var_data(self)

remove the listener function for accelerometer variance data frames

remove_listener_shake_events(self)

remove the listener function for shake events

remove_listener_tilt_events(self)

remove the listener function for tilt events

return_acks(self, acks_on)

determines whether the siftable library will returns acknowledgements from the
siftable, such as: ‘ok acc calibrate’
communication with the siftable will be much faster if
acknowledgement returning is off. (takes True/False)

screen_awake(self)

puts the screen into awake mode (also see screen_sleep)

screen_bright_max(self)

sets the screen brightness to its maximum value

screen_bright_min(self)

sets the screen brightness to its minimum value

screen_bright_val(self, val)

sets the screen brightness to a given value on [0-255]

screen_clear(self)

clears any graphics on the screen, returning it to all black pixels

screen_sleep(self)

puts the screen into power-saving sleep mode (also see screen_awake)

var_count(self)

returns the number of variable / value bindings on the current application page

var_delete(self, name)

removes a variable / value binding from the current application page. if there
is no such binding, returns an error

var_get(self, name)

returns the value associated with a given variable name, if that binding
exists on the current application page. if there is no variable with
that name, returns None

var_set(self, name, val)

writes a variable / value binding to the flash memory, on the
current application page

One useful aspect of the present invention is that it provides a platform upon which an interaction language for SNUIs can be developed. The interactions that comprise such a language are physical manipulations to single or multiple TUI manipulatives that can be sensed with the onboard sensors. A library of manipulations and metaphors, analogous to point-and-click or drag-and-drop for the GUI but related specifically to the SNUI, can be developed, with customization possible for each SNUI and/or application. In certain applications, the system can optionally permit user customization of the gestural library.

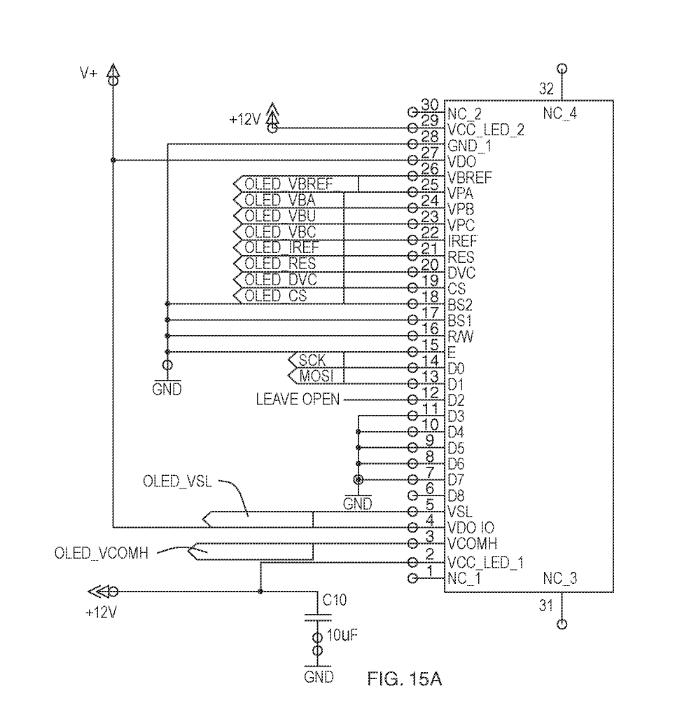

FIGS. 18-22 depict exemplary gestural language primitives that have been developed for the “siftables” implementation. It will be clear to one of skill in the art that these exemplary interaction primitives are just a few of a wide range that can be created for the present invention across varying application areas.

FIG. 18 depicts an exemplary “grouping” gestural language primitive using tangible user interface manipulatives, according to one aspect of the present invention. As shown in FIG. 18, pushing siftables together into a pile is used to group or apply a common tag to the corresponding data.

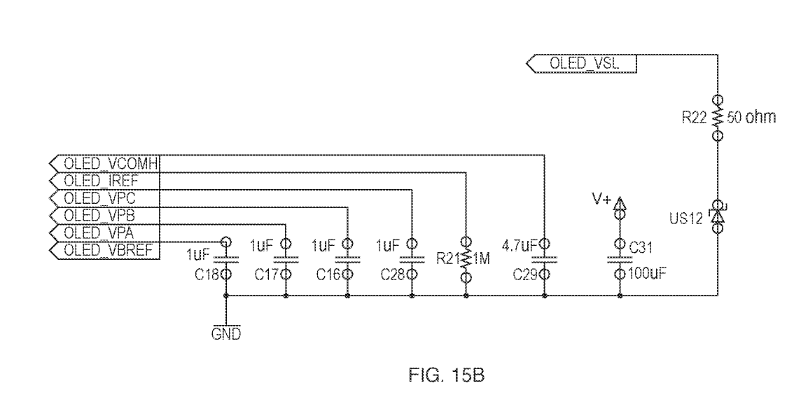

FIG. 19 depicts an exemplary “yes/no” gestural language primitive using tangible user interface manipulatives, according to one aspect of the present invention. As shown in FIG. 19, the user shakes siftable 1905 either vertically 1910 or horizontally 1920 in order to respectively provide positive or negative input to the system.

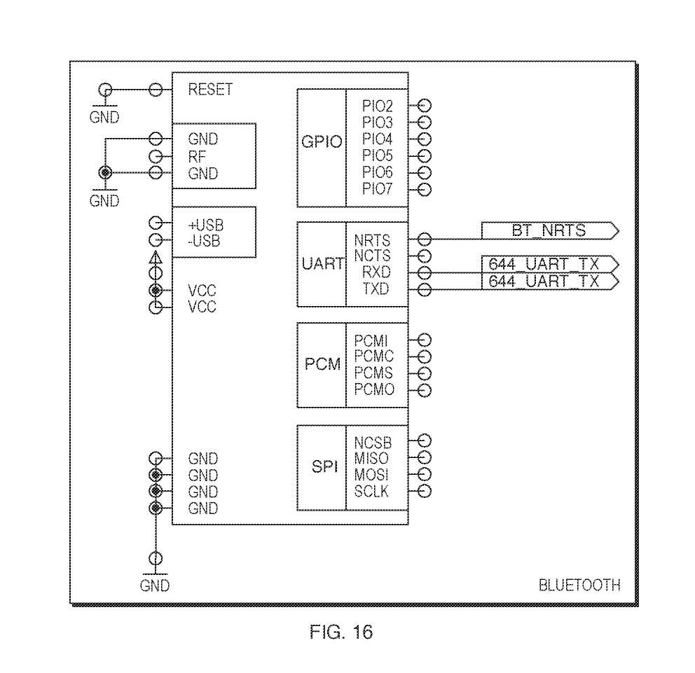

FIG. 20 depicts an exemplary “clear” gestural language primitive using tangible user interface manipulatives, according to one aspect of the present invention. As shown in FIG. 20, a user snaps siftable 2010 sharply in the downward direction in a “Sugar Pack Snap” gesture in order to clear the siftable's current data association.

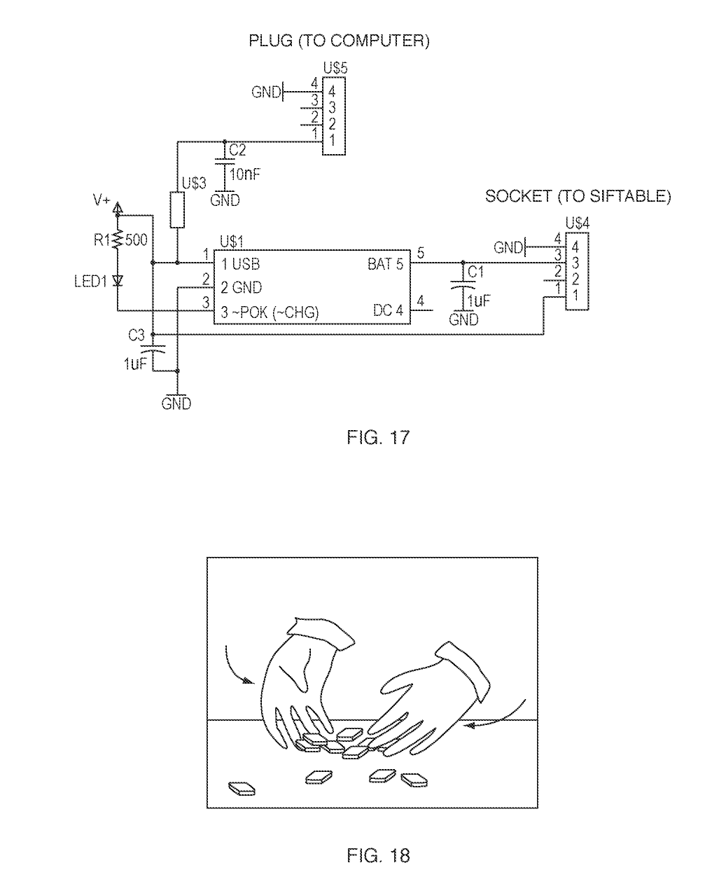

FIG. 21 depicts an exemplary “thump” gestural language primitive using tangible user interface manipulatives, according to one aspect of the present invention. In FIG. 21, a user thumps his or her first 2110 on the table, bumping all siftables 2120 at once in order to swap in a new set of data associations.

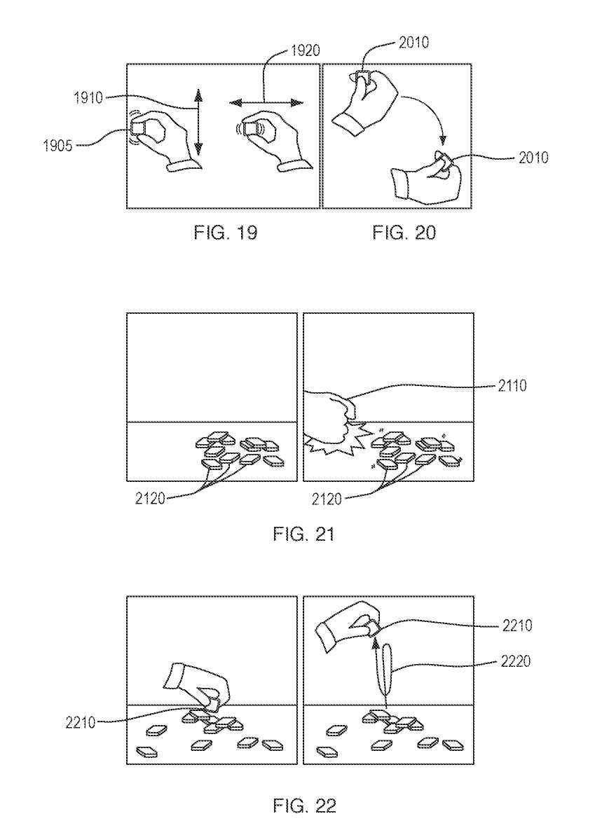

FIG. 22 depicts an exemplary “gather” gestural language primitive using tangible user interface manipulatives, according to one aspect of the present invention. In FIG. 22, a single siftable 2210 from an established group can be made to represent all data from the group by means of circular motion 2220.

It will be clear to one of skill in the art that the present invention may be advantageously employed in a wide rage of applications, including, but not limited to, media manipulation and management (such as photo sorting), use as a live performance instrument for video and/or audio, editing of video and/or audio, project planning, meeting management, game platform, educational activities, picture-in-picture system/TV control, ambient physical information widgets, user interface device for Computer-Aided-Drafting (CAD), wearable social network display, and financial monitoring and manipulation. In any of these applications, it is clear that the ability of the invention to synchronize actions performed using the manipulatives with a representation of the same data on a computer or an Internet-based system provides valuable functionality. While not all applications will require this synchronization between the manipulatives and a computer or an Internet-based system, it is an option that may be advantageously provided for any of them.

Media organization and manipulation system. TUI manipulatives according to the present invention can visually represent media, such as, but not limited to, digital song files, photos, videos, and emails, by displaying a small visual representation of the media on their screens. Other manipulatives may optionally represent tags, labels, or titles for collecting and grouping of content. Using the TUI manipulatives, the media can be organized by physical manipulation, and these manipulations may in turn create effects on the computer where the original content resides. For instance, a tag manipulative may be brought near an existing group in order to attach a label to the content or to organize those media in an album on the user's computer. Media and tags can be changed or manipulated via individual gestures.

A task particularly well-suited to the present invention is digital photograph organization. For example, a group of photos from a user's camera might include a series of images from the user's latest vacation. Thumbnails of the photographs to be sorted are transmitted wirelessly to the TUI manipulatives by a host computer. The user physically creates groupings by pushing the manipulatives into piles. The devices sense these movements and impacts using their accelerometers, and use their radios to share information about these events amongst each other. When more than one manipulative is bumped at nearly the same time, a grouping is created back on the host computer. The photographs on the user's computer are then automatically placed into a folder together. Bumping a “label” manipulation with the word “vacation” into the group can then apply the label to the group, naming the group on the user's computer and grouping the images for the user's convenience in later browsing. It can be seen that, using the present invention, the task of sorting digital images is now much closer to a physical photograph organization activity that leverages a users' manual dexterity.

Live performance instrument. In one embodiment of this application, TUI manipulatives are used as an instrument or interface for the live production of audio or video streams. Each manipulative corresponds to audio and/or video clips, to a “sequence/measure” container, to live video and/or audio streams, or to visual and/or audio effects. The user can arrange the sequence manipulatives in a row to form a timeline. The timeline itself can be represented visually as a line running across all the manipulatives that are arranged edge to edge, indicating that they are part of a temporal progression. A visual cursor sweeps across this line, showing the playback position of the media. The media is played through external (off-manipulative) speakers or displays in real time, controlled at least in part by information transmitted wirelessly via the manipulatives' radios. Effects can be applied by either touching an “effect manipulative” to a clip or by gesturing with the “clip manipulative” itself. For example, a ‘reverb’ effect manipulative may be applied to a manipulative representing an audio sample such as a guitar riff. The sample immediately acquires a reverb sound wherever it appears in the currently active sequence, and aspects of this sound may be manipulated by movements to the manipulative itself or to the “reverb” manipulative. Some ‘global’ manipulatives may also affect the entire stream at once. For example, a tempo manipulative can be tilted back and forth to affect the overall speed at which the cursor sweeps through the timeline. All of these manipulations control a sequence in real-time, which may be simultaneously presented on a large display or displays and/or a set of audio speakers.

Editor for video/audio. Like the live performance instrument, in this application manipulatives represent clips or effects. But instead of controlling a display or speaker in real-time, this tool allows the user to construct a sequence of video clips using manipulatives in order to edit together a final piece. Clips can be edited on-manipulatives (e.g., rolls, ripples, trims, and other manipulations) using gestures, and the result may be previewed on the manipulative's screen. These same gestures apply to the live performance instrument as well. The user can arrange the manipulative clips linearly or in a branching manner to explore and edit timelines quickly, trying different possibilities by re-arranging the relevant manipulatives. These timelines represent edits of the designated clips and can be viewed on a large display. Again, ‘global’ manipulatives may affect the entire timeline; for example, one manipulative may allow the user to scrub through the edited timeline shown on the large display.

Project planning. This application is a physical and interactive way to produce flow charts and ‘Gantt’-style charts. TUI manipulatives may represent people, actions or states of a project or process, and they may be arranged into a diagram to create orderings and dependencies. Real-time feedback (visual on the manipulatives, visual on a nearby screen or projection, auditory, or tactile on the manipulatives themselves) may notify the user of problems or other relevant status. The structure of the process model or chart is constructed as the individual manipulatives are placed proximately to each other and they wirelessly communicate their neighbor state to a nearby computer where the overall structure is kept up-to-date with the real-world manipulations. In this way the manipulatives provide a real-time constraint satisfaction solver, featuring physical manipulation elements, but in which the resulting structure is captured digitally and saved for future examination, manipulation, and distribution. The application can feature two-way updates between the physical representation on the manipulatives and a software application.

Meeting Management. To schedule and organize meetings, TUI manipulatives may represent people or organizations. The user may arrange manipulatives into groups to schedule a meeting with the people represented. Conflicts may be transmitted wirelessly by radio from the user's computer (which has access to the schedules of the other participants) and indicated visually to the user in real-time via the graphical display. This application is an example of a ‘constraint satisfaction’ application, in which the user is attempting to organize data, and wherein some organizations of data produce conflicts, such as scheduling a meeting with a worker at a time in which he or she is not available. In this, and other constraint satisfaction problems, the manipulatives help the user to quickly experiment with different arrangements to find a valid solution without creating conflicts. At a meeting, people and action items can each be represented by individual manipulatives that show a visual representation of their designation. To accept a task, a meeting participant bumps their manipulative into a task manipulative. Visual feedback on the individual participant manipulatives may illustrate which tasks the participant has agreed to, as well as other features of the commitment such as estimated time or cost, other resources required, etc. During the meeting, physical manipulations of the TUI manipulatives may permit their use as a voting interface or as a way to subtly annotate or comment on the ongoing meeting in real-time. Interactions during the meeting can be captured and wirelessly transmitted by radio to a nearby computer, where they can be saved to calendars and other productivity software, and communicated to the participants for later review.

Game platform. There are a large number of games, such as, but not limited to, yu-gi-oh, magic: the gathering, mahjong, scrabble, boggle, and dominos, that currently make use of non-electronic tokens or objects. TUI manipulatives can be used as active tokens for these games, augmenting the games with responses to physical gestures and spatial configurations, automatic state-tracking and scorekeeping, visual feedback and engaging animations. For instance, in an augmented game of dominoes, each manipulative can display the visual representation of a single domino and uses its infrared neighbor-detection to determine when it is placed next to another manipulative. Visual feedback can be generated to indicate whether a given arrangement is valid with respect to the rules of the particular game. The manipulatives can also show visual feedback indicating to which player they belong, with, for example, a uniquely colored border or by a characteristic icon displayed in some location on the screen. Physical manipulations of the manipulatives during these games, such as arranging them spatially, or moving them gesturally, can contribute new elements to the existing structure of the game. For instance, in an augmented version of Magic: The Gathering, spells may be cast by moving a manipulative in a spatial pattern (1-dimensional, 2-dimensional, or 3-dimensional), and battles may be fought by placing a manipulative from one player's collection next to a manipulative from the other player's collection. The manipulatives can show a visual representation of the character or the function that they represent at each moment, and as the game progresses story-enhancing animations could be shown on the manipulatives. Details of the spatial arrangement could have meaning to the gameplay as well. For example, placing two manipulatives face-to-face could initiate a battle, while placing them side-by-side could initiate a cooperative action in the game.

Educational activities (language, vocabulary, math, logic, etc.). In an educational setting, TUI manipulatives may be used to implement learning activities, wherein the manipulatives display visual representations of content, and learners place the devices into spatial arrangements that reflect their understanding of the content. For instance, manipulatives could visually display symbols such as letters, numbers, variables, operators, chemical elements, and the learner could arrange them into linear sequences or two-dimensional topologies in order to form sentences, equations, molecules, and more. The end results may correspond to ‘correct’ or ‘wrong’ arrangements based on the task domain and the spatial configuration that the user created, and visual feedback can indicate this. Alternately, the visual content displayed on the manipulatives' screens can change such that a valid answer is displayed whenever the user places the manipulatives into a configuration. The manipulatives sense their neighbors using infrared, and the overall topology is determined either by the manipulatives themselves or by software running on the server with which the manipulatives are in wireless communication. For each arrangement, or at other moments during the interaction, the system can compute the overall or partial arrangements and present the learner with immediate feedback about their arrangement via on-manipulative or auditory feedback. This system could be viewed as a constraint-satisfaction application, and this type of visual representation and on-manipulative feedback is applicable to a wide range of similar applications. Alternatively, the system can log all of the student's arrangements as part of a more creative exercise, such as narrative creation, and the results can be visualized on the learner's computer or on the internet during the process or afterwards.

Picture-in-picture system/TV control. TUI manipulatives can also be used in conjunction with larger screens. For instance, used with a television screen, a manipulative can be used to implement a feature like “picture-in-picture”, showing a continually-updated visual feed from a channel different from the channel being shown on the main display. This may be accomplished by wirelessly transmitting a live video stream, or by sending periodically updated still images from the monitored secondary channel to the manipulative. The origin of this stream or procession of images can be either from the television itself if it features wireless communication, or from a computer working in conjunction with the television, such as a home media center or a “set-top box”. The communication can optionally be bi-directional as well; gestural interaction (for example: lifting, shaking, tilting) may, for example, be used to change the channel on the television to the channel being monitored on the manipulative. An extension of this configuration would be that a collection of multiple manipulatives can each show previews of separate channels, and physically manipulating a given manipulative in a particular manner (for example: lifting, shaking, tilting) could switch the television to show that particular channel. Other gestures might reveal the upcoming schedule of the represented channel; for example, tilting the manipulative left to right would scroll through that timeline. Shaking the manipulative might tell a DVR or set-top box to record the selected program. These interactions would rely on wireless communication between the television/computer/set-top-box and the manipulative or collection of manipulatives.

Ambient physical information widgets. In this application, TUI manipulatives display live information feeds, such as, but not limited to, weather, news headlines, or stock information. This information is transmitted wirelessly to the manipulative from a nearby server computer connected to the Internet. The visual rendering may be done on the manipulative, or may be computed on the server and transmitted as complete images to the manipulative. Each manipulative could alternately show a video feed, or some other visual representation of activity at a remote location. For instance, the activity at a motion sensor in an elderly relative's house could be shown. The sensor and data collection system at the remote location is connected to the Internet and periodically uploads its current state. Then, the Internet-connected server at the user's location retrieves this data and makes it available to the manipulative (or the manipulative might directly access this information itself, depending on its communication capabilities). The manipulatives can be arranged in a user's physical space, for instance on their (physical) desktop, bedside table, kitchen counter, or in some other location. Each manipulative is thus a part of a user's physical life/work space and shows continually updated information in a manner that can be viewed and understood quickly with little attention focus required.

UI device for Computer-Aided-Drafting (CAD). A single TUI manipulative, or group of manipulatives can be used as a control interface for computer-aided-drafting software, replacing or supplementing the computer mouse. Lifting and moving the manipulative can fluidly change the angle of view on a larger computer screen. The manipulatives' screens may show which tool they represent or which visual projection they are designated to manipulate. This is an example of a general class of UI possibilities in which a set of manipulatives replaces or supplements the existing mouse and keyboard, offering concurrent multi-point discrete or continuous control into a software application on a computer. Additionally, in this application or in others, TUI manipulatives may be used as a “window” into particular parts of a computer-generated virtual space; for instance, showing a view of the three-dimensional space that updates as the user moves the manipulative around physically.

Wearable Social Network Display. A visual representation of a user's social network identity can be displayed on a TUI manipulative that they carry with them or that they wear as a piece of jewelry on their body, clothing, or personal possessions, such as backpack or shoulder bag. The manipulative can wirelessly retrieve updated information about the user's profile, and optionally the profiles of the user's contacts as well, from the user's personal computer when the user is at home, or can access this information when the user is away from the computer or otherwise “on the go” by connecting to the user's mobile phone. At any time, the manipulative can be used both as a display, showing elements from the user's online profile, and as an interface to manipulate the profile, allowing the user to modify the profile and forge new connections with other users in the physical world. The manipulative may have access to all of the user's online information, or to only a subset of this information; for example, it may be able to display the user's profile picture and to transmit the user's profile URL, email address, or other information to another user's manipulative.

With one such an application, when users are in the same physical place, they may use their manipulative together to access content from each others' profiles or to manipulate their profiles in real-time. For instance, if two users place their manipulatives next to each other, this expression of intimacy could create a ‘friend’ relationship in their social network representation or could strengthen an already-existing connection. These real-world interactions and updates may be exposed to contacts in a user's social network in the form of a “feed” or other information representation. An example of this is the “feed” mechanism in Facebook, where the online interactions that users or their contacts engage in are made visible to other participants as a continually updated log. The user's profile may also be edited using the manipulative, by using gestures such as tilting, shaking, or 3D spatial movements in order to select information for inclusion or exclusion from on-the-go interactions. These manipulations of the users' social network representation may propagate immediately to change the online representation, if the manipulative can access the Internet via its radio either directly or through a nearby computer or mobile phone, or they may be stored for update at a later time when such network access becomes available.

Financial monitoring and manipulation. Similar to the Ambient Physical Information Widgets application, in this application each TUI manipulative shows an information feed—in this case related to financial information. The content for this information feed may be collected from online sources by software running on a server (either in the user's location, or remotely), then transmitted wirelessly to the manipulative. Software on the manipulative shows the information in an appealing and easily glance-able manner, in order to allow a user to efficiently monitor a number of separate information feeds. For instance, a manipulative might show the current price of a stock, the difference in value from a previous reading, or a longer-term graphical summary. The difference between this application and the Ambient Physical Information Widgets application is that here the manipulative can also be used as an interface for navigating the information and for making transactions. For instance, tapping on a manipulative might change the visualization currently being displayed. By shaking or tilting a manipulative, the owner's holdings in a particular stock could be increased or decreased immediately. These interactions rely on a wireless connection to software on a server, which would have access and authority to make transactions with the user's accounts. This connectivity permits a collection of TUI manipulatives to become an active part of a trader's information-rich environment that may currently be dominated by large passive display screens.

In another possible application for financial purposes, a certain group of TUI represent investment options—for instance, various stocks, mutual funds, or certificates of deposit. Each manipulative displays which option it represents. One manipulative is the “action” manipulative, and shows a distinct visual image indicating it as such. Placing the “action” manipulative next to an investment manipulative initiates investment from the user's financial account into that particular option, either all at once, or in such a manner that the amount invested depends on a continuous parameter such as tilt, or the length of time that the manipulatives are kept proximate. Visual feedback on the manipulatives indicates the success of, or the degree of, the transaction. The transactions can be made immediately, or the record of the interactions can be kept, and a “commit” action at the end of the interaction (either using a manipulative or using a computer) can trigger the action to be taken. The manipulatives have wireless communication with a server, which has network-based access to financial accounts and the ability to make transactions on the user's behalf.

In another possible financial application, a group of TUI manipulatives represents a user's accounts and the investment or money-management options offered by a financial institution. A user may be at home, or they may be at the location of the institution in consultation with a member of the institution. The manipulatives display a visual representation of the account, instrument, or action that they represent, and financial arrangements such as the purchase or adoption of certain financial instruments (stocks, bonds, etc.) or the transfer of money between accounts, can be achieved by manipulation of the manipulatives representing these entities. Again, the transactions may be made at the time of the interaction or later, and the manipulative have wireless communication with a server that has network-based access to financial accounts and the ability to make transactions on the user's behalf.

The present invention takes design principles for addressing human-computer interaction problems and applies sensor network technologies to them in order to both yield new kinds of tangible interfaces and new design principles specific to the possibilities inherent in Sensor Network User Interfaces. The tangible user interface manipulatives of the present invention give direct physical embodiment to information items and digital media content, allowing people to use their hands and bodies to manipulate these data instead of relying on virtual cursors and windows. By leveraging people's ability to manipulate physical objects, the present invention radically simplifies the way people interact with information and media and enables a new degree of directness in physically manipulating and interpreting information and media.

While a preferred embodiment is disclosed, many other implementations will occur to one of ordinary skill in the art and are all within the scope of the invention. Each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. Other arrangements, methods, modifications, and substitutions by one of ordinary skill in the art are therefore also considered to be within the scope of the present invention, which is not to be limited except by the claims that follow.

What is claimed is:

1. A sensor network user interface, comprising:
a sensor-based distributed tangible user interface, comprising:
a set of special-purpose tangible user interface manipulative devices, wherein:
the set of manipulative devices form and are members of the distributed user interface,
each manipulative device has no significant functionality independent of membership in the distributed user interface, being useable only as part of the set of manipulative devices under the control of the sensor network user interface,
each manipulative device is configured to directly detect the presence and location of the other manipulative devices in the set solely by being placed proximate to any of the other manipulative devices in the set,
each manipulative device is independently physically manipulable relative to the other manipulative devices in the set, and
each manipulative device comprises:
at least one wireless communications device;
a visual display for digital content;
a power source;
at least one movement sensor;
at least one neighborhood wireless communications device for detecting the presence of nearby manipulative devices; and
at least one manipulative device controller adapted for:
receiving data from the movement sensor;
processing the received data to derive movement parameters;
at least one of forwarding the derived movement parameters or initiating behavior of the manipulative device in response to the derived movement parameters;
sensing, using the neighborhood wireless communication device, the position of at least one nearby manipulative device;
processing the position of, and any communication received from, the sensed nearby manipulative device in order to derive neighborhood information; and
at least one of forwarding the derived neighborhood information or initiating behavior of the manipulative device in response to the derived neighborhood information; and
at least one user interface controller, the user interface controller being adapted for controlling the behavior of the sensor-based distributed tangible user interface by coordinating and controlling the behavior of the set of manipulative devices as a group by:
sending digital content or behavior instructions to individual manipulative devices;
receiving at least one of derived neighborhood information or derived movement parameters from at least one of the manipulative devices;
processing any received derived neighborhood information and derived movement parameters to derive instructions about management of the digital content or program behavior for the set of manipulative devices; and
changing program behavior or managing the digital content for the set of manipulative devices according to the derived instructions.

2. The sensor network user interface of claim 1, the user interface controller being further adapted for sending at least one of revised digital content or behavior instructions to individual manipulative devices according to the derived instructions.

3. The sensor network user interface of claim 1, each manipulative device further comprising at least one feedback device for presenting responsive information to a user.

4. The sensor network user interface of claim 1, wherein the user interface controller resides on one of the manipulative devices.

5. The sensor network user interface of claim 1, wherein the movement sensor is an accelerometer.

6. The sensor network user interface of claim 1, each manipulative device further comprising memory for storing at least one of digital content or program instructions.

7. A tangible user interface manipulative device, comprising:
a special-purpose manipulative device specifically adapted to form and be a member of a sensor-based distributed tangible user interface comprising a defined set of special-purpose manipulative devices that are controlled as a group by a central controller adapted to control the distributed tangible user interface by controlling the set of manipulative devices as a group, wherein:
the manipulative device has no significant functionality independent of membership in the distributed tangible user interface, being useable only as part of the set of manipulative devices under control of the central controller,
the manipulative device is configured to directly detect the presence and location of other manipulative devices in the set when placed proximate to those other manipulative devices,
the manipulative device is independently physically manipulable relative to the other manipulative devices in the set, and
the manipulative device comprises:
a visual display;
a power source;
at least one wireless communications device, the wireless communications device being adapted for receiving behavior commands or digital content for display on the visual display from the central controller;
at least one movement sensor;
at least one neighborhood wireless communications device for detecting the presence of nearby manipulative devices; and
at least one manipulative device controller adapted for:
sensing, using the neighborhood wireless communication device, the position of any nearby manipulative device;
at least one of:
processing the sensed position of, and any communication received from, the sensed nearby manipulative device in order to derive neighborhood information;
initiating behavior as a result of the sensed position or derived neighborhood information; and
forwarding the sensed position or derived neighborhood information to the central controller using the wireless communications device;
receiving data from the movement sensor; and
at least one of:
processing the received data to derive movement parameters;
initiating behavior as a result of the data or movement parameters; and
forwarding the derived movement parameters or the received data to the central controller using the wireless communications device.

8. The tangible user interface manipulative device of claim 7, wherein at least one of the derived movement parameters and derived neighborhood information are forwarded to a computing device.

9. The tangible user interface manipulative device of claim 7, further comprising at least one feedback device for presenting responsive information to a user.

10. The tangible user interface manipulative device of claim 7, wherein the movement sensor is an accelerometer.

11. The tangible user interface manipulative device of claim 7, further comprising memory for storing at least one of digital content or program instructions.

12. A method for facilitating user interaction with digital content or application programs, comprising the steps of:
displaying a visual representation of at least one of digital content or program control elements on a sensor-based distributed tangible user interface, the distributed user interface comprising a set of special-purpose manipulative devices that are controlled as a group by a computing device adapted for controlling the distributed user interface, wherein:
only a subset of the digital content or program control elements is displayed on any individual manipulative device,
the set of manipulative devices form and are members of the distributed user interface,
each manipulative device has no significant functionality independent of membership in the distributed user interface, being useable only as part of the set of manipulative devices under the control of the sensor network user interface,
each manipulative device is configured to directly detect the presence and location of the other manipulative devices in the set solely by being placed proximate to any of the other manipulative devices in the set, and
each manipulative device is independently physically manipulable relative to the other manipulative devices in the set;
directly detecting, by at least one of the manipulative devices, a location-based relationship between the manipulative device and at least one other of the manipulative devices in the set; and
deriving digital content relationship information or instructions from the detected location-based relationship.

13. The method of claim 12, further comprising the step of forwarding the derived digital content relationship information or instructions to the computing device.

14. The method of claim 13, further comprising the step of managing the digital content or application program behavior according to the derived digital content relationship information or instructions received by the computing device.

15. The method of claim 14, further comprising the step of sending at least one of revised digital content or behavior instructions to individual ones of the manipulative devices in the set according to the derived digital content relationship information or instructions received by the computing device.

16. The method of claim 13, further comprising the steps of:
processing the derived digital content relationship information or instructions received by the computing device; and
managing the digital content or application program behavior according to the processed digital content relationship information or instructions.

17. The method of claim 16, further comprising the step of sending revised digital content or behavior instructions to individual manipulative devices in the set according to the processed digital content relationship information or instructions.

18. The method of claim 12, further comprising the step of presenting responsive information to a user via the manipulative devices.

19. The method of claim 12, wherein the instructions relate to management of the digital content or program behavior.

20. The method of claim 12, wherein the instructions relate to management of the behavior of the manipulative device.
